(19) United States
(12) Patent Application Publication
(10) Pub. No.: US 2024/0260136 A1
(43) Pub. Date: Aug. 1, 2024

(54) METHODS AND APPARATUSES FOR CONTROL OF MULTICAST BROADCAST SERVICE

(71) Applicant: Telefonaktiebolaget LM Ericsson (publ), Stockholm (SE)

(72) Inventors: Jie Ling, Shanghai (CN); Juying Gan, Shanghai (CN); Yunjie Lu, Shanghai (CN); Yong Yang, Kållered (SE)

(21) Appl. No.: 18/578,396

(22) PCT Filed: Jul. 26, 2022
(86) PCT No.: PCT/EP2022/070873

§ 371 Date: Jan. 11, 2024

(30) Foreign Application Priority Data
Jul. 30, 2021 (WO) PCT/CN2021/109808

(51) Int. Cl. H04W 76/40; H04W 76/12; H04W 76/30

(52) U.S. Cl. CPC H04W 76/40; H04W 76/12; H04W 76/30

(57) ABSTRACT

Methods and apparatuses for control of multicast broadcast service (MBS) are disclosed. According to an embodiment, a session management function (SMF) sends, to a user plane function (UPF), a first request for modifying a packet forwarding control protocol (PFCP) session for a protocol data unit (PDU) session associated with an MBS session. The first request comprises an identification of the MBS session. The SMF receives, from the UPF, a first response to the first request.

### TECHNICAL FIELD

Embodiments of the disclosure generally relate to communication, and, more particularly, to methods and apparatuses for control of multicast broadcast service (MBS).

### BACKGROUND

This section introduces aspects that may facilitate better understanding of the present disclosure. Accordingly, the statements of this section are to be read in this light and are not to be understood as admissions about what is in the prior art or what is not in the prior art.

In 3rd generation partnership project (3GPP) technical specification (TS) 23.247 V1.0.0, clause 7.2.1.3 describes how a user equipment (UE) joins a multicast session. Specifically, with reference to FIG. 7.2.1.3-1 showing protocol data unit (PDU) session modification for UE joining multicast session, clause 7.2.1.3 provides the following description:
4. By using Nmbsmf_Information_Request request (MBS Session ID). SMF interacts with the MB-SMF to retrieve multicast QoS flow information of the indicated MBS session. For multicast transport between MB-UPF and content provider, if it is the first UE joining the multicast group, and MB-UPF has not joined the multicast tree in the MBS configuration procedure, the MB-SMF requests the MB-UPF to join the multicast tree towards the AF/MBSF, otherwise MB-SMF will not send the request to the MB-UPF.

[Conditional] Step 11 is used for 5GC Individual MBS traffic delivery. e.g. the related NG-RAN does not support multicast. If the shared tunnel between the UPF(PSA) and MB-UPF for individual delivery have not been established, steps 11a to 11e are executed.
11a. If unicast transport for the multicast data between UPF and MB-UPF is to be used. SMF allocates a downlink tunnel endpoint and configures UPF. Or, SMF requests UPF to allocate a downlink tunnel ID.
11b. SMF invokes Nmbsmf_Reception_Request request (MBS Session ID. DL tunnel info) towards MB-SMF that includes MBS Session ID and downlink tunnel info of UPF, for establishing the multicast session distribution between MB-UPF and UPF.

In 3GPP TS 23.247 V1.0.0, clause 7.2.2.2 describes how a UE leaves a multicast session. Specifically, with reference to FIG. 7.2.2.2-1 showing UE initiated multicast MBS session leave, clause 7.2.2.2 provides the following description:
3. [conditional] If the UE is the last UE served with 5GC Individual MBS traffic delivery method in this UPF for this MBS session, the SMF configures the UPF to stop receiving multicast data from the MB-UPF and invokes Nmbsmf_MBSession_Update Request (MBS session ID. [tunnel information]) to release the tunnel between UPF and MB-UPF for this MBS session.
   If unicast transport is used, tunnel information is included to indicate the tunnel between UPF and MB-UPF.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for control of MBS. In particular, one of the problems to be solved by the disclosure is that the existing solution may cause multiple tunnels (e.g. N19mb tunnels) to be established between a user plane function (UPF) and a multicast broadcast UPF (MB-UPF) for the same MBS session in certain scenario.

According to a first aspect of the disclosure, there is provided a method performed by a session management function (SMF). The method may comprise sending, to a UPF, a first request for modifying a packet forwarding control protocol (PFCP) session for a protocol data unit (PDU) session associated with an MBS session. The first request may comprise an identification of the MBS session. The method may further comprise receiving, from the UPF, a first response to the first request.

In this way, the same tunnel can be ensured between the UPF and an MB-UPF for the same MBS session.

In an embodiment of the disclosure, the first request may further comprise information required for receiving data of the MBS session via multicast transport.

In an embodiment of the disclosure, the information required for receiving data of the MBS session via multicast transport may comprises: a common downlink tunnel identifier (ID); and a source specific multicast address (SSM).

In an embodiment of the disclosure, the first request may further comprise: a packet detection rule (PDR) for identifying the data of the MBS session; and a forwarding action rule (FAR) associated with the PDR.

In an embodiment of the disclosure, the PDU session may be the first PDU session joining the MBS session in the SMF. The first request may indicate the UPF to allocate, for the MBS session, tunnel information about the UPF endpoint of a tunnel between the UPF and an MB-UPF.

In an embodiment of the disclosure, the first response may comprise: tunnel information about the UPF endpoint of a tunnel between the UPF and an MB-UPF; and a first indicator indicating whether the tunnel information is newly allocated.

In an embodiment of the disclosure, the first response may comprise a second indicator indicating whether the UPF has joined a multicast group of the MBS session without allocating tunnel information about the UPF endpoint of a tunnel between the UPF and an MB-UPF.

In an embodiment of the disclosure, the method may further comprise, when the first indicator indicates that the tunnel information is newly allocated, sending the tunnel information to an MB-SMF for establishing a multicast session distribution between the UPF and the MB-UPF.

In an embodiment of the disclosure, tunnel information about the UPF endpoint of a tunnel between the UPF and an MB-UPF has been received and stored previously by the SMF for the MBS session in the UPF. The first request may comprise the tunnel information.

In an embodiment of the disclosure, the method may further comprise sending, to the UPF, a second request for modifying the PFCP session for the PDU session. The second request may indicate the UPF to remove a PDR for identifying the data of the MBS session. The method may further comprise receiving, from the UPF, a second response to the second request.

In an embodiment of the disclosure, the second response may comprise a third indicator indicating whether a tunnel between the UPF and an MB-UPF is to be released.

In an embodiment of the disclosure, the method may further comprise, when the third indicator indicates that the tunnel is to be released, sending, to an MB-SMF, information about the release of the tunnel.

According to a second aspect of the disclosure, there is provided a method performed by a UPF. The method may comprise receiving, from an SMF, a first request for modifying a PFCP session for a PDU session associated with an MBS session. The first request may comprise an identification of the MBS session. The method may further comprise sending, to the SMF, a first response to the first request.

In this way, the same tunnel can be ensured between the UPF and an MB-UPF for the same MBS session.

In an embodiment of the disclosure, the first request may further comprise information required for receiving data of the MBS session via multicast transport.

In an embodiment of the disclosure, the information required for receiving data of the MBS session via multicast transport may comprise: a common downlink tunnel ID; and an SSM.

In an embodiment of the disclosure, the first request may further comprise: a PDR for identifying the data of the MBS session; and an FAR associated with the PDR.

In an embodiment of the disclosure, the PDU session may be the first PDU session joining the MBS session in the SMF. The first request may indicate the UPF to allocate, for the MBS session, tunnel information about the UPF endpoint of a tunnel between the UPF and an MB-UPF.

In an embodiment of the disclosure, the first response may comprise: tunnel information about the UPF endpoint of a tunnel between the UPF and an MB-UPF; and a first indicator indicating whether the tunnel information is newly allocated.

In an embodiment of the disclosure, the first response may comprise a second indicator indicating whether the UPF has joined a multicast group of the MBS session without allocating tunnel information about the UPF endpoint of a tunnel between the UPF and an MB-UPF.

In an embodiment of the disclosure, tunnel information about the UPF endpoint of a tunnel between the UPF and an MB-UPF may have been received and stored previously by the SMF for the MBS session in the UPF. The first request may comprise the tunnel information.

In an embodiment of the disclosure, the method may further comprise receiving, from the SMF, a second request for modifying the PFCP session for the PDU session. The second request may indicate the UPF to remove a PDR for identifying the data of the MBS session. The method may further comprise sending, to the UPF, a second response to the second request.

In an embodiment of the disclosure, the second response may comprise a third indicator indicating whether a tunnel between the UPF and an MB-UPF is to be released.

According to a third aspect of the disclosure, there is provided a method performed by an SMF. The method may comprise sending, to a UPF, a first request for establishing a first PFCP session for an MBS session. The first request may comprise an identification of the MBS session. The method may further comprise receiving, from the UPF, a first response to the first request.

In this way, the same tunnel can be ensured between the UPF and an MB-UPF for the same MBS session.

In an embodiment of the disclosure, the first request may further comprise information required for receiving data of the MBS session via multicast transport.

In an embodiment of the disclosure, the information required for receiving data of the MBS session via multicast transport may comprise: a common downlink tunnel ID; and an SSM.

In an embodiment of the disclosure, the first request may further comprise: a first PDR for identifying the data of the MBS session; and a first FAR associated with the first PDR.

In an embodiment of the disclosure, the first request may be sent for the first terminal device joining the MBS session in the SMF. The first request may indicate the UPF to allocate, for the MBS session, tunnel information about the UPF endpoint of a tunnel between the UPF and an MB-UPF.

In an embodiment of the disclosure, the first response may comprise: tunnel information about the UPF endpoint of a tunnel between the UPF and an MB-UPF; and a first indicator indicating whether the tunnel information is newly allocated.

In an embodiment of the disclosure, the first response may comprise a second indicator indicating whether the UPF has joined a multicast group of the MBS session without allocating tunnel information about the UPF endpoint of a tunnel between the UPF and an MB-UPF.

In an embodiment of the disclosure, the method may further comprise, when the first indicator indicates that the tunnel information is newly allocated, sending the tunnel information to an MB-SMF for establishing a multicast session distribution between the UPF and the MB-UPF.

In an embodiment of the disclosure, the method may further comprise, when the first PFCP session has been established, sending, to the UPF, a second request for modifying a second PFCP session for a PDU session associated with the MBS session. The second request may comprise a second PDR for identifying the data of the MBS session from an internal interface of the UPF, and a second FAR for forwarding the data of the MBS session to a terminal device. The method may further comprise receiving, from the UPF, a second response to the second request.

In an embodiment of the disclosure, the method may further comprise, when a last terminal device leaves the MBS session in the SMF, sending, to the UPF, a third request for deleting the first PFCP session. The method may further comprise receiving, from the UPF, a third response to the third request.

In an embodiment of the disclosure, the third response may comprise a third indicator indicating whether a tunnel between the UPF and an MB-UPF is to be released.

In an embodiment of the disclosure, the method may further comprise, when the third indicator indicates that the tunnel is to be released, sending, to an MB-SMF, information about the release of the tunnel.

According to a fourth aspect of the disclosure, there is provided a method performed by a UPF. The method may comprise receiving, from an SMF, a first request for establishing a first PFCP session for an MBS session. The first request may comprise an identification of the MBS session. The method may further comprise sending, to the SMF, a first response to the first request.

In this way, the same tunnel can be ensured between the UPF and an MB-UPF for the same MBS session.

In an embodiment of the disclosure, the first request may further comprise information required for receiving data of the MBS session via multicast transport.

In an embodiment of the disclosure, the information required for receiving data of the MBS session via multicast transport may comprise: a common downlink tunnel ID; and an SSM.

In an embodiment of the disclosure, the first request may further comprise: a first PDR for identifying the data of the MBS session; and a first FAR associated with the first PDR.

In an embodiment of the disclosure, the first request may be received for the first terminal device joining the MBS session in the SMF. The first request may indicate the UPF to allocate, for the MBS session, tunnel information about the UPF endpoint of a tunnel between the UPF and an MB-UPF.

In an embodiment of the disclosure, the first response may comprise: tunnel information about the UPF endpoint of a tunnel between the UPF and an MB-UPF; and a first indicator indicating whether the tunnel information is newly allocated.

In an embodiment of the disclosure, the first response may comprise a second indicator indicating whether the UPF has joined a multicast group of the MBS session without allocating tunnel information about the UPF endpoint of a tunnel between the UPF and an MB-UPF.

In an embodiment of the disclosure, the method may further comprise, when the first PFCP session has been established, receiving, from the SMF, a second request for modifying a second PFCP session for a PDU session associated with the MBS session. The second request may comprise a second PDR for identifying the data of the MBS session from an internal interface of the UPF, and a second FAR for forwarding the data of the MBS session to a terminal device. The method may further comprise sending, to the SMF, a second response to the second request.

In an embodiment of the disclosure, the method may further comprise, when a last terminal device leaves the MBS session in the SMF, receiving, from the SMF, a third request for deleting the first PFCP session. The method may further comprise sending, to the SMF, a third response to the third request.

In an embodiment of the disclosure, the third response may comprise a third indicator indicating whether a tunnel between the UPF and an MB-UPF is to be released.

According to a fifth aspect of the disclosure, there is provided an apparatus implementing an SMF. The apparatus may comprise at least one processor and at least one memory. The at least one memory may contain instructions executable by the at least one processor, whereby the apparatus may be operative to send, to a UPF, a first request for modifying a PFCP session for a PDU session associated with an MBS session. The first request may comprise an identification of the MBS session. The apparatus may be further operative to receive, from the UPF, a first response to the first request.

In an embodiment of the disclosure, the apparatus may be operative to perform the method according to the above first aspect.

According to a sixth aspect of the disclosure, there is provided an apparatus implementing a UPF. The apparatus may comprise at least one processor and at least one memory. The at least one memory may contain instructions executable by the at least one processor, whereby the apparatus may be operative to receive, from an SMF, a first request for modifying a PFCP session for a PDU session associated with an MBS session. The first request may comprise an identification of the MBS session. The apparatus may be further operative to send, to the SMF, a first response to the first request.

In an embodiment of the disclosure, the apparatus may be operative to perform the method according to the above second aspect.

According to a seventh aspect of the disclosure, there is provided an apparatus implementing an SMF. The apparatus may comprise at least one processor and at least one memory. The at least one memory may contain instructions executable by the at least one processor, whereby the apparatus may be operative to send, to a UPF, a first request for establishing a first PFCP session for an MBS session. The first request may comprise an identification of the MBS session. The apparatus may be further operative to receive, from the UPF, a first response to the first request.

In an embodiment of the disclosure, the apparatus may be operative to perform the method according to the above third aspect.

According to an eighth aspect of the disclosure, there is provided an apparatus implementing a UPF. The apparatus may comprise at least one processor and at least one memory. The at least one memory may contain instructions executable by the at least one processor, whereby the apparatus may be operative to receive, from an SMF, a first request for establishing a first PFCP session for an MBS session. The first request may comprise an identification of the MBS session. The apparatus may be further operative to send, to the SMF, a first response to the first request.

In an embodiment of the disclosure, the apparatus may be operative to perform the method according to the above fourth aspect.

According to a ninth aspect of the disclosure, there is provided a computer program product. The computer program product may contain instructions which when executed by at least one processor, cause the at least one processor to perform the method according to any of the above first to fourth aspects.

According to a tenth aspect of the disclosure, there is provided a computer readable storage medium. The computer readable storage medium may store thereon instructions which when executed by at least one processor, cause the at least one processor to perform the method according to any of the above first to fourth aspects.

According to an eleventh aspect of the disclosure, there is provided an apparatus implementing an SMF. The apparatus may comprise a sending module for sending, to a UPF, a first request for modifying a PFCP session for a PDU session associated with an MBS session. The first request may comprise an identification of the MBS session. The apparatus may further comprise a reception module for receiving, from the UPF, a first response to the first request.

According to a twelfth aspect of the disclosure, there is provided an apparatus implementing an UPF. The apparatus may comprise a reception module for receiving, from an SMF, a first request for modifying a PFCP session for a PDU session associated with an MBS session. The first request may comprise an identification of the MBS session. The apparatus may further comprise a sending module for sending, to the SMF, a first response to the first request.

According to a thirteenth aspect of the disclosure, there is provided an apparatus implementing an SMF. The apparatus may comprise a sending module for sending, to a UPF, a first request for establishing a first PFCP session for an MBS session. The first request may comprise an identification of the MBS session. The apparatus may further comprise a reception module for receiving, from the UPF, a first response to the first request.

According to a fourteenth aspect of the disclosure, there is provided an apparatus implementing an UPF. The apparatus may comprise a reception module for receiving, from an SMF, a first request for establishing a first PFCP session for an MBS session. The first request may comprise an identification of the MBS session. The apparatus may further comprise a sending module for sending, to the SMF, a first response to the first request.

According to a fifteenth aspect of the disclosure, there is provided a method implemented in a communication system including an SMF and a UPF. The method may comprise all steps of the methods according to the above first and second aspects.

According to a sixteenth aspect of the disclosure, there is provided a communication system. The communication system may comprise an apparatus implementing an SMF according to the above fifth or eleventh aspect and an apparatus implementing a UPF according to the above sixth or twelfth aspect.

According to a seventeenth aspect of the disclosure, there is provided a method implemented in a communication system including an SMF and a UPF. The method may comprise all steps of the methods according to the above third and fourth aspects.

According to an eighteenth aspect of the disclosure, there is provided a communication system. The communication system may comprise an apparatus implementing an SMF according to the above seventh or thirteenth aspect and an apparatus implementing a UPF according to the above eighth or fourteenth aspect.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating MBS traffic delivery methods in 5GC;

FIG. 2 is a diagram illustrating a scenario in individual MBS traffic delivery;

FIG. 3 is a diagram illustrating an exemplary communication system into which an embodiment of the disclosure is applicable;

FIG. 4 is a flowchart illustrating a method performed by an SMF according to an embodiment of the disclosure;

FIG. 5 is a flowchart illustrating a method performed by an SMF according to an embodiment of the disclosure;

FIG. 6 is a flowchart illustrating a method performed by a UPF according to an embodiment of the disclosure;

FIG. 7 is a flowchart illustrating a method performed by a UPF according to an embodiment of the disclosure;

FIG. 8 is a flowchart illustrating a method performed by an SMF according to an embodiment of the disclosure;

FIG. 9 is a flowchart illustrating a method performed by an SMF according to an embodiment of the disclosure;

FIG. 10 is a flowchart illustrating a method performed by an SMF according to an embodiment of the disclosure;

FIG. 11 is a flowchart illustrating a method performed by a UPF according to an embodiment of the disclosure;

FIG. 12 is a flowchart illustrating a method performed by a UPF according to an embodiment of the disclosure;

FIG. 13 is a flowchart illustrating a method performed by a UPF according to an embodiment of the disclosure;

FIGS. 14A-14B are flowcharts illustrating an exemplary process according to an embodiment of the disclosure;

FIGS. 15A-15C are flowcharts illustrating an exemplary process according to an embodiment of the disclosure;

FIG. 16 is a flowchart illustrating UE initiated multicast MBS session leave;

FIG. 17 is a block diagram showing an apparatus suitable for use in practicing some embodiments of the disclosure;

FIG. 18 is a block diagram showing an apparatus implementing an SMF according to an embodiment of the disclosure;

FIG. 19 is a block diagram showing an apparatus implementing a UPF according to an embodiment of the disclosure;

FIG. 20 is a block diagram showing an apparatus implementing an SMF according to an embodiment of the disclosure; and

FIG. 21 is a block diagram showing an apparatus implementing a UPF according to an embodiment of the disclosure.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

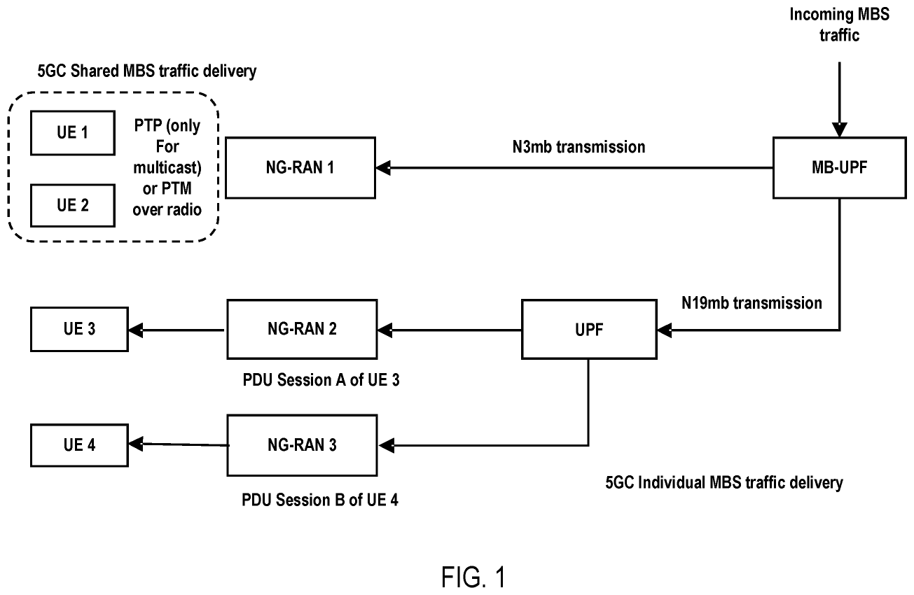

### FIG. 1

FIG. 1 is a diagram illustrating MBS traffic delivery methods in 5th generation core (5GC). As shown, unlike the 5GC shared MBS traffic delivery which is implemented via N3mb transmission, the 5GC individual MBS traffic delivery is implemented via N19mb transmission. In the 5GC individual MBS traffic delivery, 5GC receives a single copy of MBS data packets and delivers separate copies of those MBS data packets to individual UEs via per-UE PDU sessions. Hence, for each such UE, one PDU session is required to be associated with a multicast session.

As mentioned hereinbefore, in clause 7.2.1.3 “multicast session join and session establishment procedure” of 3GPP TS 23.247 V1.0.0, according to steps 11a˜11b, it is the SMF that determines to set up the tunnel entity of N19mb at the UPF if unicast transport over N19mb applies. In clause 7.2.2.2 “MBS session Leave”, according to step 3, it is the SMF that determines to release the tunnel entity of N19mb at the UPF if unicast transport over N19mb applies. Thus, clauses 7.2.1.3 and 7.2.2.2 assume there is only one SMF handling the UE join and UE leave for a specific MBS Session.

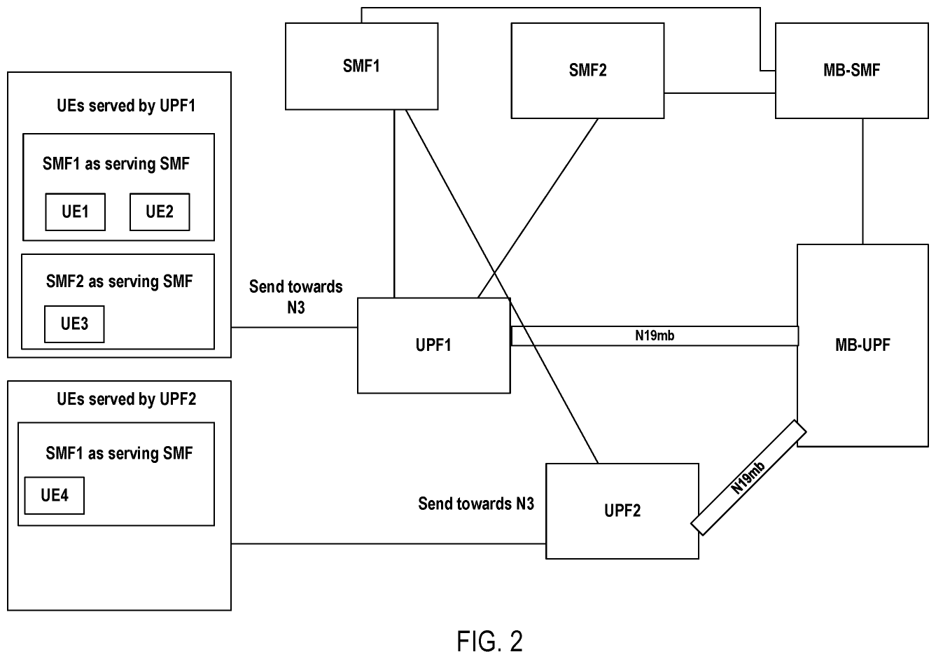

### FIG. 2

However, there may be multiple SMFs handling UE join and UE leave for the same MBS Session, and the multiple SMFs may be controlling the same UPF. For example, in the scenario shown in FIG. 2, UE 1 served by SMF 1 and UE 3 served by SMF 2 join the same MBS session via the same UPF 1. Such scenario of multiple SMFs controlling the same UPF is not addressed in the existing solution defined in the above technical specification, which may be problematic.

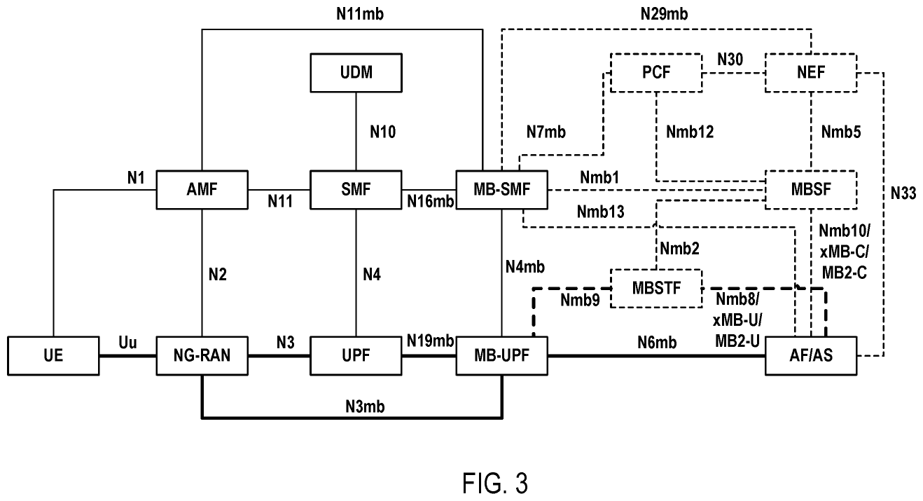

The present disclosure proposes an improved solution for control of MBS. Hereinafter, the solution will be described in detail with reference to FIGS. 3-21.

### FIG. 3

FIG. 3 is a diagram illustrating an exemplary communication system into which an embodiment of the disclosure is applicable. It is FIGS. 5.1-2 (“5G MBS system architecture in reference point representation”) of 3GPP TS 23.247 V1.0.0. As shown, the communication system comprises a user equipment (UE), a next generation radio access network (NG-RAN), a user plane function (UPF), a multicast broadcast UPF (MB-UPF), an application function/application server (AF/AS), an access and mobility management function (AMF), a session management function (SMF), an MB SMF (MB-SMF), an MBS transport function (MBSTF), an MBS function (MBSF), a unified data management (UDM), a policy control function (PCF), and a network exposure function (NEF). The functional description of the above entities is specified in clause 5 of 3GPP TS 23.247 V1.0.0, which is incorporated herein by reference in its entirety.

Note that within the context of this disclosure, the term the terminal device may also be referred to as, for example, device, access terminal, UE, mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a terminal device (or UE) may represent a machine or other device that performs monitoring and/or measurements, and transmits the results of such monitoring and/or measurements to another terminal device (or UE) and/or a network equipment. In this case, the terminal device (or UE) may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

As used herein, the term “communication system” refers to a system following any suitable communication standards, such as the first generation (1G), 2G, 2.5G, 2.75G, 3G, 4G, 4.5G, 5G communication protocols, and/or any other protocols either currently known or to be developed in the future. Furthermore, the communications between a terminal device and a network node in the communication system may be performed according to any suitable generation communication protocols, including, but not limited to, 1G, 2G, 2.5G, 2.75G, 3G, 4G, 4.5G, 5G communication protocols, and/or any other protocols either currently known or to be developed in the future. In addition, the specific terms used herein do not limit the present disclosure only to the communication system related to the specific terms, which however can be more generally applied to other communication systems.

Note that the network function (or network entity) mentioned in this document may be implemented either as a network element on a dedicated hardware, as a software instance running on a dedicated hardware, or as a virtualized function instantiated on an appropriate platform, e.g. on a cloud infrastructure.

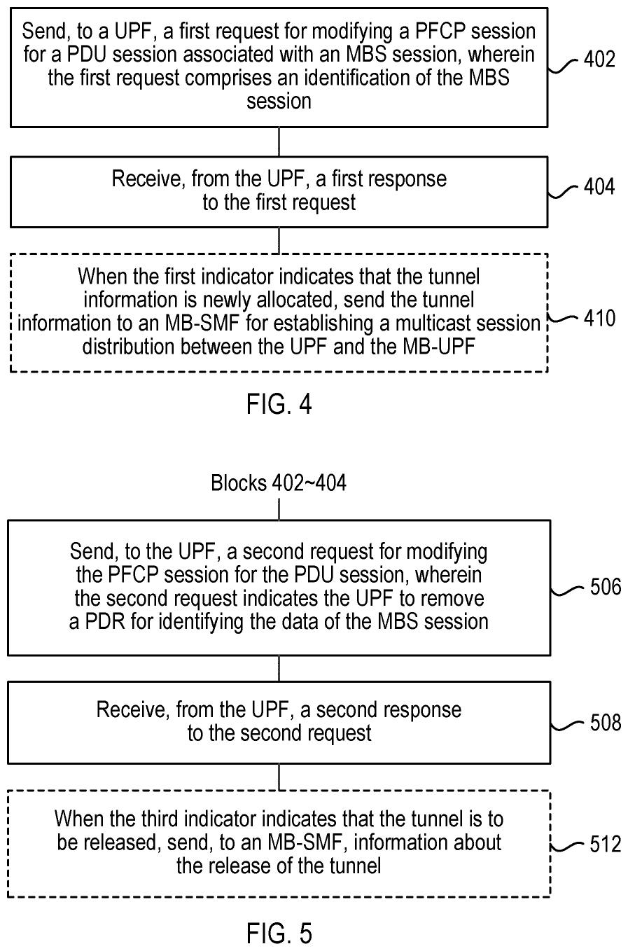

### FIG. 4

FIG. 4 is a flowchart illustrating a method performed by an SMF according to an embodiment of the disclosure. At block 402, the SMF sends, to a UPF, a first request for modifying a PFCP session for a PDU session associated with an MBS session. The first request comprises an identification (or an identifier) of the MBS session. For example, a terminal device (e.g. UE 3 in FIG. 1) joining the MBS session may receive data of the MBS session (which may be simply referred to as MBS session data hereinafter) via the PDU session (e.g. PDU session A in FIG. 1). By including the identification of the MBS session, the first request may indicate that the PFCP session used for control the PDU session is now subject to receiving the data of the MBS session. In the scenario of multiple SMFs controlling the same UPF which prefers unicast transport via a tunnel (e.g. N19mb tunnel) between the UPF and an MB-UPF for the MBS session, since every SMF provides the identification of corresponding MBS session when sending the corresponding first request, the UPF can be allowed to allocate and use the same tunnel (e.g. N19mb tunnel) for the same MBS session across different SMFs.

Optionally, the first request may further comprise information required for receiving the data of the MBS session via multicast transport, which may be simply referred to as multicast transport information hereinafter. For example, the multicast transport information may comprise: a common downlink tunnel ID; and a source specific multicast address (SSM). The SSM may comprise a source IP address and a multicast address of the MBS session. By including the multicast transport information, if the UPF prefers multicast transport, the UPF can be allowed to join the multicast group of the MBS session. In this way, there is no need for the SMF to know whether the UPF prefers unicast transport or multicast transport.

As a request for PFCP session control, the first request may comprise: a PDR for identifying the data of the MBS session; and a FAR associated with the PDR. With the included PDR and FAR for the corresponding PDU session, separate copies of the MBS session data received by the UPF can be delivered to individual terminal devices via corresponding PDU sessions.

At block 404, the SMF receives, from the UPF, a first response to the first request. As an example, the first response may comprise: tunnel information about the UPF endpoint of the tunnel (e.g. N19mb tunnel) between the UPF and the MB-UPF; and a first indicator indicating whether the tunnel information is newly allocated. The tunnel information may comprise a tunnel endpoint ID (TEID) and an Internet protocol (IP) address of the UPF. With the first indicator, the SMF can determine whether or not to report the tunnel information to the MB-UPF. For instance, when the first indicator indicates that the tunnel information is newly allocated, the SMF may send, at block 410, the tunnel information to the MB-SMF for establishing a multicast session distribution between the UPF and the MB-UPF.

As another example, the first response may comprise a second indicator indicating whether the UPF has joined the multicast group of the MBS session without allocating the tunnel information. As yet another example, the first response may comprise the tunnel information, the first indicator and the second indicator. In a case where the PDU session is the first PDU session joining the MBS session in the SMF, the first request may indicate the UPF to allocate the tunnel information for the MBS session. On the other hand, in a case where the tunnel information has been received and stored previously by the SMF for the MBS session in the UPF, the first request may comprise the tunnel information.

### FIG. 5

FIG. 5 is a flowchart illustrating a method performed by an SMF according to an embodiment of the disclosure. As shown, the method at least comprises blocks 402-404 described above and blocks 506-508. At block 506, the SMF sends, to the UPF, a second request for modifying the PFCP session for the PDU session. The second request indicates the UPF to remove the PDR for identifying the data of the MBS session. In this way, the delivery of the MBS session data via the PDU session to the terminal device can be terminated. At block 508, the SMF receives, from the UPF, a second response to the second request. For example, the second response may comprise a third indicator indicating whether the tunnel between the UPF and the MB-UPF is to be released. With the third indicator, the SMF can determine whether or not to inform the MB-SMF of the release of the tunnel. For instance, when the third indicator indicates that the tunnel is to be released, the SMF sends, to the MB-SMF, information about the release of the tunnel at block 512.

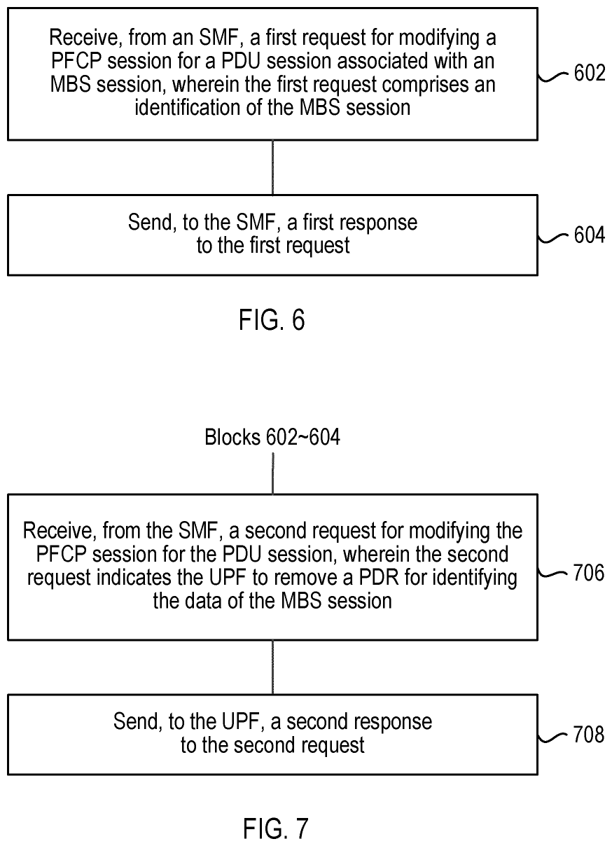

### FIG. 6

FIG. 6 is a flowchart illustrating a method performed by a UPF according to an embodiment of the disclosure. At block 602, the UPF receives, from an SMF, a first request for modifying a PFCP session for a PDU session associated with an MBS session. The first request comprises an identification of the MBS session. Optionally, the first request may further comprise information required for receiving data of the MBS session via multicast transport, which may be simply referred to as multicast transport information hereinafter. The multicast transport information may comprise: a common downlink tunnel ID; and an SSM. As a request for PFCP session control, the first request may comprise: a PDR for identifying the data of the MBS session; and a FAR associated with the PDR. Block 602 corresponds to block 402 and the description given above with respect to block 402 may also apply to block 602.

At block 604, the UPF sends, to the SMF, a first response to the first request. As an example, if the UPF prefers unicast via a tunnel (e.g. N19mb tunnel) between the UPF and an MB-UPF for the MBS session, and if the first request does not comprise tunnel information about the UPF endpoint of the tunnel, the UPF may determine whether the tunnel information has been allocated previously for the MBS session identified in the first request. If the tunnel information has not been allocated previously, the UPF may allocate the tunnel information for the MBS session. In this case, the allocated tunnel information may be included in the first response. The first response may further include a first indicator set to indicate that the tunnel information is newly allocated. On the other hand, if the tunnel information has been allocated previously, the UPF may include the previously allocated tunnel information into the first response. Accordingly, the first indicator included in the first response may be set to indicate that the tunnel information is an existing one. Thus, with the identification of the MBS session included in the first request, it is possible for the same tunnel between the UPF and the MB-UPF to be used for the same MBS session. Besides, if the UPF prefers unicast and if the first request comprises the tunnel information, the tunnel information and the first indicator may be omitted in the first response.

As another example, if the UPF prefers multicast, the UPF may join the multicast group of the MBS session by using the multicast transport information included in the first request. In this case, the first response may include a second indicator set to indicate that the UPF has joined the multicast group without allocating the tunnel information. As yet another example, the first response may comprise the tunnel information, the first indicator indicating whether the tunnel information is newly allocated, and the second indicator indicating whether the UPF has joined the multicast group without allocating the tunnel information.

### FIG. 7

FIG. 7 is a flowchart illustrating a method performed by a UPF according to an embodiment of the disclosure. As shown, the method comprises blocks 602-604 described above and blocks 706-708. At block 706, the UPF receives, from the SMF, a second request for modifying the PFCP session for the PDU session. The second request indicates the UPF to remove the PDR for identifying the data of the MBS session. By removing the PDR, the delivery of the MBS session data via the PDU session to the terminal device can be terminated. At block 708, the UPF sends, to the UPF, a second response to the second request. For example, the UPF may determine whether the terminal device associated with the PDU session for which the PDR is removed is the last terminal device in the UPF leaving the MBS session. If the result of the determination is positive (i.e. the terminal device associated with the PDU session for which the PDR is removed is the last terminal device in the UPF leaving the MBS session), the UPF may determine to de-allocate the tunnel between the UPF and the MB-UPF and include, in the second response, a third indicator set to indicate that the tunnel is to be released. On the other hand, if the result of the determination is negative, the third indicator included in the second response may be set to indicate that the tunnel is not to be released.

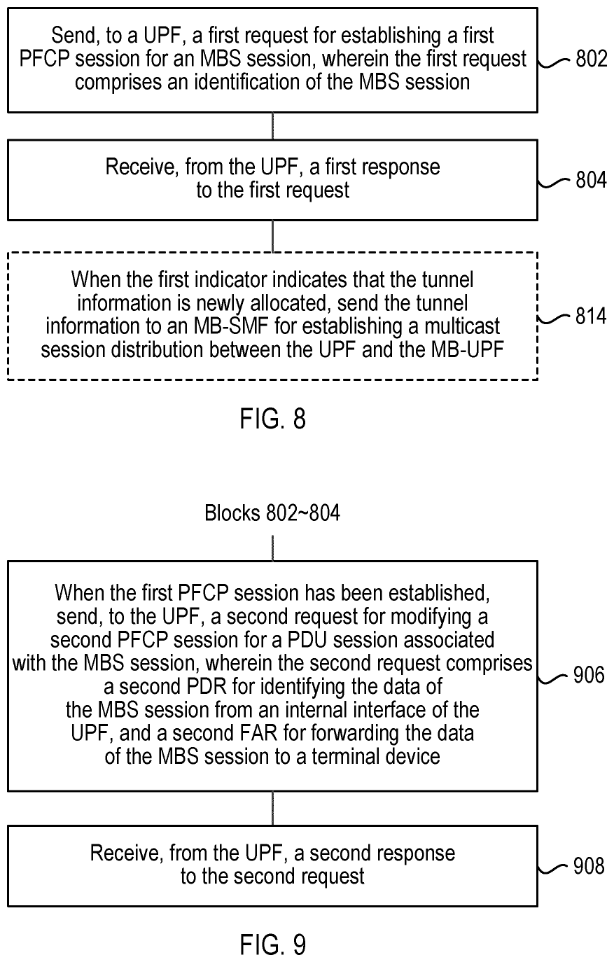

### FIG. 8

FIG. 8 is a flowchart illustrating a method performed by an SMF according to an embodiment of the disclosure. At block 802, the SMF sends, to a UPF, a first request for establishing a first PFCP session for an MBS session. The first request comprises an identification of the MBS session. In the scenario of multiple SMFs controlling the same UPF which prefers unicast transport via a tunnel (e.g. N19mb tunnel) between the UPF and an MB-UPF for the MBS session, since every SMF provides the identification of corresponding MBS session when sending the corresponding first request, the UPF can be allowed to allocate and use the same tunnel (e.g. N19mb tunnel) for the same MBS session across different SMFs.

Optionally, the first request may further comprise information required for receiving the data of the MBS session via multicast transport, which may be simply referred to as multicast transport information hereinafter. For example, the multicast transport information may comprise: a common downlink tunnel ID; and an SSM. The SSM may comprise a source IP address and a multicast address of the MBS session. By including the multicast transport information, if the UPF prefers multicast transport, the UPF can be allowed to join the multicast group of the MBS session. In this way, there is no need for the SMF to know whether the UPF prefers unicast transport or multicast transport.

As a request for PFCP session control, the first request may comprise: a first PDR for identifying the data of the MBS session; and a first FAR associated with the first PDR. The first FAR may enable the data of the MBS session identified by the first PDR to be sent to an internal interface of the UPF. With the included first PDR and first FAR, a copy of the MBS session data can be received by the UPF from the MB-UPF.

At block 804, the SMF receives, from the UPF, a first response to the first request. As an example, the first response may comprise: tunnel information about the UPF endpoint of the tunnel (e.g. N19mb tunnel) between the UPF and the MB-UPF; and a first indicator indicating whether the tunnel information is newly allocated. The tunnel information may comprise a TEID and an IP address of the UPF. With the first indicator, the SMF can determine whether or not to report the tunnel information to the MB-UPF. For instance, when the first indicator indicates that the tunnel information is newly allocated, the SMF may send, at block 814, the tunnel information to the MB-SMF for establishing a multicast session distribution between the UPF and the MB-UPF.

As another example, the first response may comprise a second indicator indicating whether the UPF has joined the multicast group of the MBS session without allocating the tunnel information. As yet another example, the first response may comprise the tunnel information, the first indicator and the second indicator.

The first request may be sent for the first terminal device joining the MBS session in the SMF. In this case, the first request may indicate the UPF to allocate the tunnel information for the MBS session. Afterwards, for other terminal devices joining the MBS session in the SMF, there is no need to send first request for them since the first PFCP session has been established.

### FIG. 9

FIG. 9 is a flowchart illustrating a method performed by an SMF according to an embodiment of the disclosure. As shown, the method comprises blocks 802-804 described above and blocks 906-908. At block 906, when the first PFCP session has been established, the SMF sends, to the UPF, a second request for modifying a second PFCP session for a PDU session associated with the MBS session. For example, a terminal device (e.g. UE 3 in FIG. 1) joining the MBS session may receive data of the MBS session (which may be simply referred to as MBS session data hereinafter) via the PDU session (e.g. PDU session A in FIG. 1). The second request comprises a second PDR for identifying the data of the MBS session from the internal interface of the UPF, and a second FAR for forwarding the data of the MBS session to the terminal device. With the included second PDR and second FAR for the corresponding PDU session, separate copies of the MBS session data received by the UPF can be delivered to individual terminal devices via corresponding PDU sessions. At block 908, the SMF receives, from the UPF, a second response to the second request.

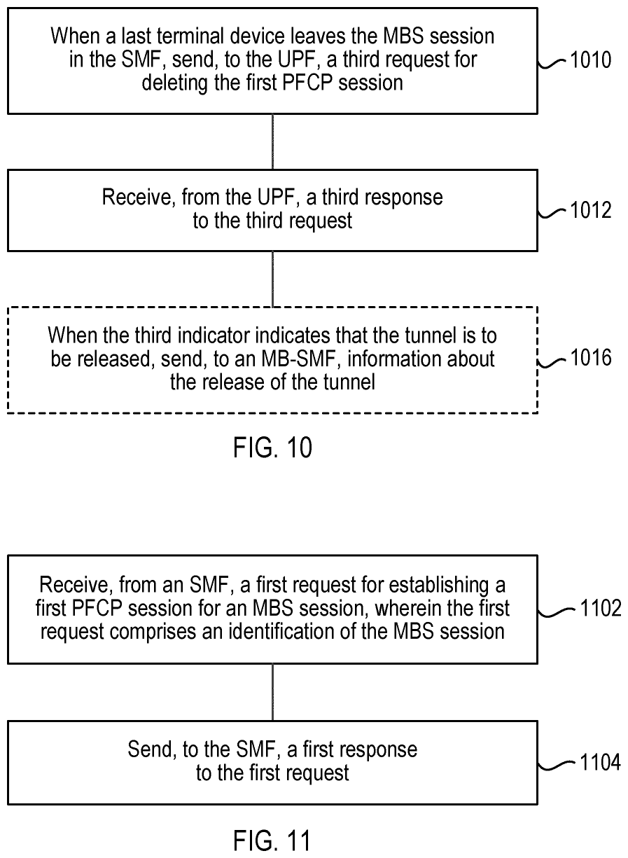

### FIG. 10

FIG. 10 is a flowchart illustrating a method performed by an SMF according to an embodiment of the disclosure. The method may be performed in a case where blocks 802-908 of FIG. 9 or blocks 906-908 have been performed. As shown, the method comprises at least blocks 1010-1012. At block 1010, when the last terminal device leaves the MBS session in the SMF, the SMF sends, to the UPF, a third request for deleting the first PFCP session. At block 1012, the SMF receives, from the UPF, a third response to the third request.

For example, the third response may comprise a third indicator indicating whether the tunnel between the UPF and the MB-UPF is to be released. With the third indicator, the SMF can determine whether or not to inform the MB-SMF of the release of the tunnel. For instance, when the third indicator indicates that the tunnel is to be released, the SMF sends, to the MB-SMF, information about the release of the tunnel at block 1016.

In addition, when a terminal device leaves the MBS session in the SMF, the SMF may further send, to the UPF, a fourth request for modifying the second PFCP session for the PDU session corresponding to this terminal device, and receive a fourth response from the UPF. The fourth request may indicate the UPF to remove the PDR for identifying the data of the MBS session from the internal interface of the UPF.

Note that if a terminal device leaving the MBS session in the SMF is not the last terminal device leaving the MBS session in the SMF, the first PFCP session for the MBS session needs to be retained. Thus, the third request will not be sent for this terminal device and the fourth request indicating the UPF to remove the PDR will be sent for the PDU session corresponding to this terminal device. Note that the terms such as “third” and “fourth” are merely used for distinguishing between different requests/responses. The fourth request is possible to take place prior to, or after, or simultaneously with the third request.

### FIG. 11

FIG. 11 is a flowchart illustrating a method performed by a UPF according to an embodiment of the disclosure. At block 1102, the UPF receives, from an SMF, a first request for establishing a first PFCP session for an MBS session. The first request comprises an identification of the MBS session. Optionally, the first request may further comprise information required for receiving data of the MBS session via multicast transport, which may be simply referred to as multicast transport information hereinafter. The multicast transport information may comprise: a common downlink tunnel ID; and an SSM. As a request for PFCP session control, the first request may comprise: a PDR for identifying the data of the MBS session; and a FAR associated with the PDR. Block 1102 corresponds to block 802 and the description given above with respect to block 802 may also apply to block 1102.

At block 1104, the UPF sends, to the SMF, a first response to the first request. As an example, if the UPF prefers unicast via a tunnel (e.g. N19mb tunnel) between the UPF and an MB-UPF for the MBS session, the UPF may determine whether tunnel information about the UPF endpoint of the tunnel has been allocated previously for the MBS session identified in the first request. If the tunnel information has not been allocated previously, the UPF may allocate the tunnel information for the MBS session. In this case, the allocated tunnel information may be included in the first response. The first response may further include a first indicator set to indicate that the tunnel information is newly allocated. On the other hand, if the tunnel information has been allocated previously, the UPF may include the previously allocated tunnel information into the first response. Accordingly, the first indicator included in the first response may be set to indicate that the tunnel information is an existing one. Thus, with the identification of the MBS session included in the first request, it is possible for the same tunnel between the UPF and the MB-UPF to be used for the same MBS session.

As another example, if the UPF prefers multicast, the UPF may join the multicast group of the MBS session by using the multicast transport information included in the first request. In this case, the first response may include a second indicator set to indicate that the UPF has joined the multicast group without allocating the tunnel information. As yet another example, the first response may comprise the tunnel information, the first indicator indicating whether the tunnel information is newly allocated, and the second indicator indicating whether the UPF has joined the multicast group without allocating the tunnel information.

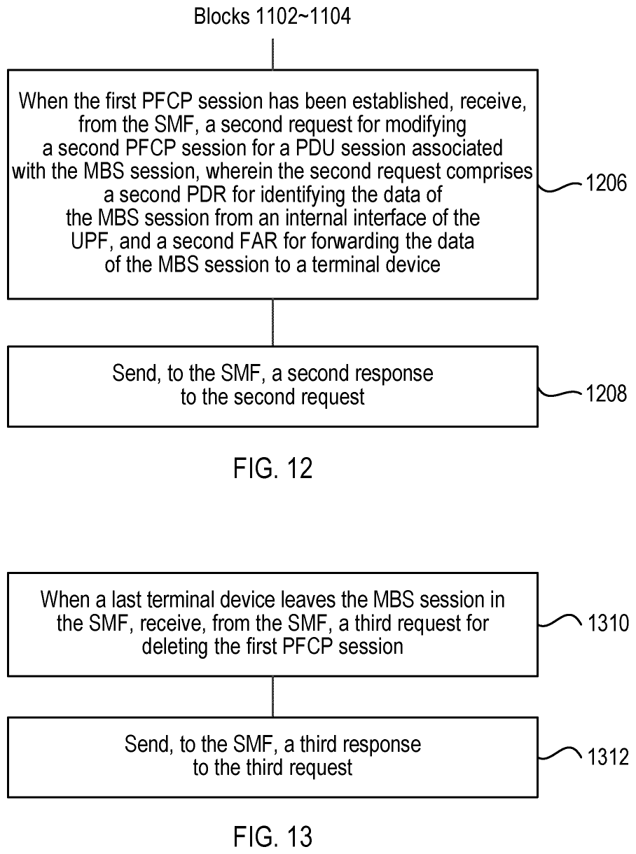

### FIG. 12

FIG. 12 is a flowchart illustrating a method performed by a UPF according to an embodiment of the disclosure. As shown, the method comprises blocks 1102-1104 described above and blocks 1206-1208. At block 1206, when the first PFCP session has been established, the UPF receives, from the SMF, a second request for modifying a second PFCP session for a PDU session associated with the MBS session. The second request comprises a second PDR for identifying the data of the MBS session from an internal interface of the UPF, and a second FAR for forwarding the data of the MBS session to a terminal device. With the included second PDR and second FAR for the corresponding PDU session, separate copies of the MBS session data received by the UPF can be delivered to individual terminal devices via corresponding PDU sessions. At block 1208, the UPF sends, to the SMF, a second response to the second request.

### FIG. 13

FIG. 13 is a flowchart illustrating a method performed by a UPF according to an embodiment of the disclosure. The method may be performed in a case where blocks 1102-1208 of FIG. 12 or blocks 1206-1208 have been performed. At block 1310, when the last terminal device leaves the MBS session in the SMF, the UPF receives, from the SMF, a third request for deleting the first PFCP session. At block 1312, the UPF sends, to the SMF, a third response to the third request. For example, the UPF may determine whether there are other SMFs having first PFCP sessions associated with the tunnel between the UPF and the MB-UPF. If there are other SMFs having first PFCP sessions associated with the tunnel, the UPF may include, in the third response, a third indicator set to indicate that the tunnel is not to be released. On the other hand, if there are no other SMFs having first PFCP sessions associated with the tunnel, the UPF may determine to de-allocate the tunnel and include, in the third response, a third indicator set to indicate that the tunnel is to be released.

Based on the above description, as exemplary examples, two alternative solutions (Alternative 1 and Alternative 2) may be provided so that the shared tunnel in a UPF for an MBS session can serve the joined UEs across multiple SMFs. In Alternative 1, SMF requests UPF to allocate shared N19mb tunnel using the PFCP Session for the PDU Session. Specifically, when a UE/PDU session determines to join a MBS session, for the PFCP session corresponding to the PDU session, the SMF sends a PFCP Session Modification Request message to the UPF, which includes: a) Multicast transport information, i.e. the Common TEID together with the source IP address, Multicast address allocated by the MB-UPF for the MBS session; b) a MBS session identification, which is used by the UPF to determine if to allocate a new N19mb DL tunnel or reuse the existing one, or to send a new IGMP JOIN the multicast tree for a new MBS session; c) a new DL PDR identifying MBS session data which is received at a local “N19mb DL TEID” at the UPF where the existing IE “Local F-TEID” in the PDI IE or Create Traffic Endpoint IE will enable the SMF to request the UPF to allocate N19mb DL Tunnel ID if the SMF has no such information available, otherwise the SMF will provide the stored N19mb DL Tunnel ID; d) the new PDR is associated with a Forwarding Action Rule to forward the received MBS session data to the UE via existing downlink N3/N9 tunnel.

Note that the Multicast transport information and the MBS session identification can be included in a new IE MBS Session Control Information which also indicates the PFCP Session is now subject to receive MBS Session data. Also note that the MBS Session Identification will enable the UPF to allocate the same N19mb DL Tunnel ID if multiple UEs are joining at the same time.

The UPF responds with a PFCP Session Modification Response message to the SMF, which includes: a) the allocated “N19mb DL Tunnel ID”; b) an indication indicating if the N19mb DL Tunnel ID is newly allocated or an existing one to allow the SMF to determine if it needs to report this N19mb DL Tunnel ID to the MB-SMF; c) an indication indicating it has joined the multicast tree from MB-UPF, so that the N19mb DL Tunnel ID is not present, in this case, the SMF need not communicate to MB-SMF either. Note that a), b) and c) may be included in a new group IE, preferably called “MBS Session Information” in corresponding to MBS Session Control Information.

The SMF will store N19mb DL Tunnel ID for subsequent UE/PDU Sessions which are served by the UPF when they join the MBS session, to use it as part of DL PDR (in the PDI or Create Tunnel Endpoint IE).

When a UE/PDU Session determines to leave the MBS session, the SMF will send a PFCP Session Modification Request message to remove the PDR to receive the MBS session data. The UPF will respond with a PFCP Session Modification Response with following additions: 1) an indication indicating the N19mb DL Tunnel is to be removed when it is the last UE/PDU session leaving the MBS session in the UPF, so to enable the SMF to report this to the MB-SMF, so that the MB-UPF will not send a copy of MBS Session data towards this N19mb DL Tunnel.

In Alternative 1, the SMF does not create a separate PFCP session to request UPF to allocate an N19mb tunnel to receive the MBS session data from the MB-UPF, which will save some extra PFCP session signalling. The SMF need not to know either, if the UPF is configured to setup a N19mb DL tunnel to receive the MBS session data, or to send IGMP Join to join the multicast tree from the MB-UPF. If the UPF can send IGMP JOIN to retrieve MBS Session data, like IPTV solution, there is no need to establish a separate session. In addition, this alternative requires UPF, for unicast delivery, to allocate an N19mb DL Tunnel to receive a single copy of MBS session data, and to replicate a copy for each PFCP session (which has joined the MBS session).

In Alternative 2, SMF requests UPF to allocate shared N19mb tunnel using a dedicated PFCP Session for the MBS Session. Specifically, when the first UE/PDU session from a SMF requests to join a MBS Session, after retrieving MBS Session Information, if the SMF knows the UPF is configured to receive MBS session data via a shared tunnel (i.e. unicast delivery), the SMF sends a PFCP Session Establishment Request message to the UPF, where it includes: 1) Multicast transport information of the MBS session; 2) a MBS session identification, which is used by the UPF to determine if to allocate a new N19mb DL tunnel or to reuse existing N19mb tunnel ID for that MBS Session; 3) a new PDR contains a Local F-TEID in the PDI or in the Create Tunnel Endpoint IE to request UPF to allocate a N19mb DL TEID for this MBS Session; 4) a new FAR to forward the MBS session data to a new interface “MBS Internal Interface”. Note that though there is no need to create a separate PFCP session for multicast delivery (so as the same for IPTV solution), information 1) is included so that the SMF can avoid to know if the UPF to use unicast or multicast to receive MBS session data.

The UPF responds with a PFCP Session Establishment Response with acceptance cause code if the PFCP session is successfully established and includes: 1) the allocated N19mb DL Tunnel ID; 2) an indication indicating if the N19mb DL Tunnel ID is newly allocated or an existing one to allow the SMF to determine if it needs to report this N19mb DL Tunnel ID to the MB-SMF, since multiple SMFs may control a same UPF, while for the same MBS session, there should be only one tunnel between the UPF and MB-UPF, so to deliver only a single copy of the MBS session data from the MB-UPF to the UPF; 3) an indication to indicate it has joined the multicast tree from MB-UPF, so that the N19mb DL Tunnel ID is not present, in this case, the SMF need not communicate to MB-SMF either. Note that the above indications 1), 2) and 3) may be included in a new group IE “MBS Session Information”.

After the dedicated PFCP session (for N19mb) is established, the SMF will send PFCP session modification request (for the PDU session joining the MBS session) to the UPF with the new PDR identifying the MBS session data from the internal interface “MBS Internal Interface” of the UPF and then forward the data to the UE via an existing FAR.

When the last UE/PDU session from a SMF determines to leave a MBS session, the SMF may decide to release the PFCP session established for N19mb (as described above). If so, the SMF will send a PFCP Session Deletion Request. In the corresponding PFCP Session Deletion Response message, the UPF need to include a new indication if the N19mb DL Tunnel is still used by other UEs served other SMFs. If so, the SMF shall not notify the MB-SMF to stop sending MBS session data to the UPF towards that N19mb tunnel.

Thus, Alternative 2 proposes an enhancement over N4 (when creating a separate PFCP session for N19mb) so that it enables the UPF to allocate the same N19mb DL Tunnel for a given MBS Session though different SMFs may anyway create their own N19mb sessions in the UPF.

Alternative 2 is like 5G VN solution (as specified in 3GPP TS 29.244, clause 5.23), where a separate PFCP session is established for N19 tunnel. However, for 5G VN, the packets received from N19 tunnel are forwarded to different set of UE(s), e.g. packet1 may be forwarded to UE1, while packet 2 may be forwarded to UE2. While for 5G MBS, all packets received from a given N19mb tunnel are sent towards the same set of UEs. This difference makes double packet inspections unnecessary. The double packet inspection will increase processing load in UPF which adds extra latency.

On the other hand, managing a separate PFCP session (for N19mb) increases additional latency for MBS service, since this has to be done before the PFCP session (corresponding to the PDU Session) can be modified to allow to receive MBS session data. In addition, this alternative will introduce some additional session signalling.

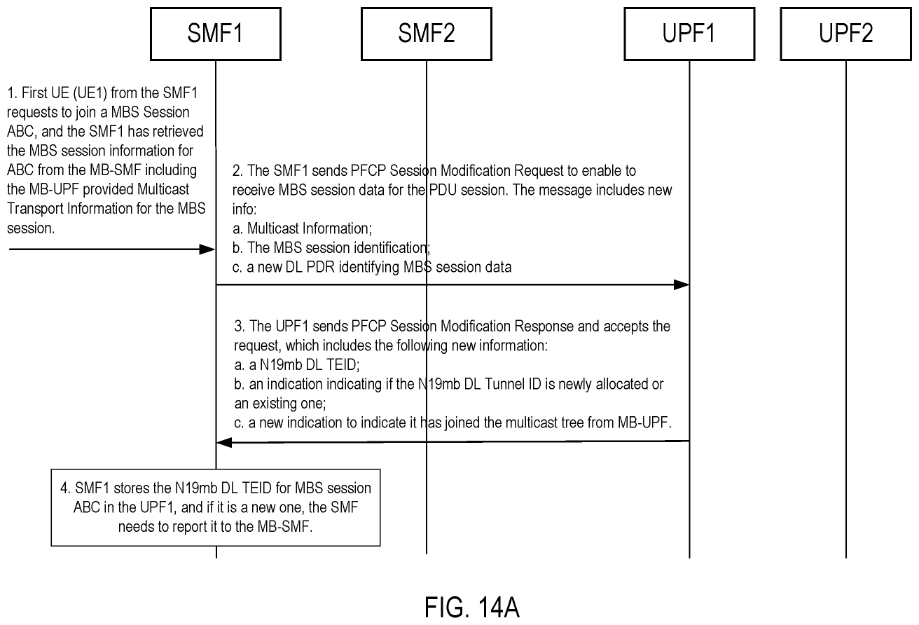

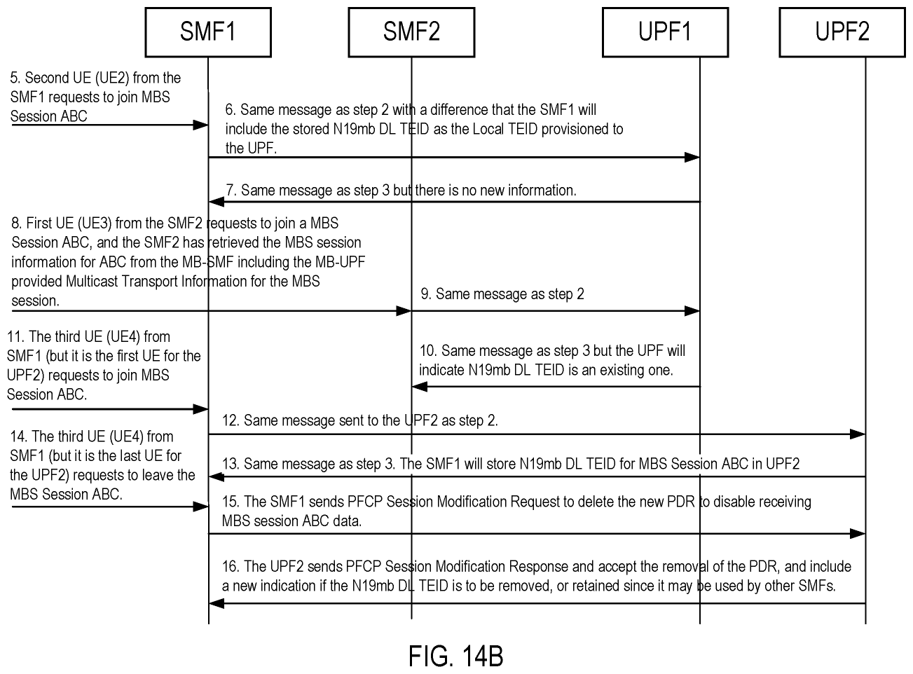

### FIGS. 14A-14B

FIGS. 14A-14B are flowcharts illustrating an exemplary process according to an embodiment of the disclosure. At step 1, the first UE (UE1) from the SMF1 (i.e. UE1 is the first UE from the viewpoint of the SMF1) requests to join a MBS Session ABC. The SMF1 has retrieved the MBS session information for ABC from the MB-SMF including the MB-UPF provided Multicast Transport Information (Common-TEID, Source IP address, and Multicast IP address) for the MBS session. At step 2, the SMF1 sends a PFCP Session Modification Request to enable to receive MBS session data for the PDU session. The message includes the following new info: a) Multicast (transport) Information (Common TEID, Source IP addr, Multicast IP addr); b) The MBS session identification; c) a new DL PDR identifying MBS session data which is received at a local Tunnel Endpoint Tunnel at the UPF where the ID of tunnel is to be allocated by the UPF, which may be called N19mb downlink (DL) TEID.

At step 3, the UPF1 sends a PFCP Session Modification Response and accepts the request, which includes the following new information: a) a N19mb DL TEID; b) an indication indicating if the N19mb DL Tunnel ID is newly allocated or an existing one; c) a new indication to indicate it has joined the multicast tree from MB-UPF, e.g. when no N19mb DL TEID is included. At step 4, the SMF1 stores the N19mb DL TEID for MBS session ABC in the UPF1. If it is a new one, the SMF1 needs to report it to the MB-SMF.

At step 5, the second UE (UE2) from the SMF1 requests to join MBS Session ABC. At step 6, the same message as step 2 is sent from the SMF1 to the UPF1, with a difference that the SMF1 will include the stored N19mb DL TEID as the Local TEID provisioned to the UPF. At step 7, the same message as step 3 is sent from the UPF1 to the SMF1, but there is no new information.

At step 8, the first UE (UE3) from the SMF2 requests to join a MBS Session ABC. The SMF2 has retrieved the MBS session information for ABC from the MB-SMF including the MB-UPF provided Multicast Transport Information (Common-TEID, Source IP address, and Multicast IP address) for the MBS session. At step 9, the same message as step 2 is sent from the SMF2 to the UPF1. At step 10, the same message as step 3 is sent from the UPF1 to the SMF2, but the UPF1 will indicate N19mb DL TEID is an existing one.

At step 11, the third UE (UE4) from the SMF1 (but it is the first UE for the UPF2) requests to join MBS Session ABC. At step 12, the same message is sent to the UPF2 as step 2. At step 13, the same message is sent to the SMF1 as step 3. The SMF1 will store N19mb DL TEID for MBS Session ABC in UPF2.

At step 14, the third UE (UE4) from the SMF1 (but it is the last UE for the UPF2) requests to leave the MBS Session ABC. At step 15, the SMF1 sends a PFCP Session Modification Request to delete the new PDR to disable receiving MBS session ABC data for the PFCP session. At step 16, the UPF2 sends a PFCP Session Modification Response and accepts the removal of the PDR, and include a new indication if the N19mb DL TEID is to be removed, or retained since it may be used by other SMFs.

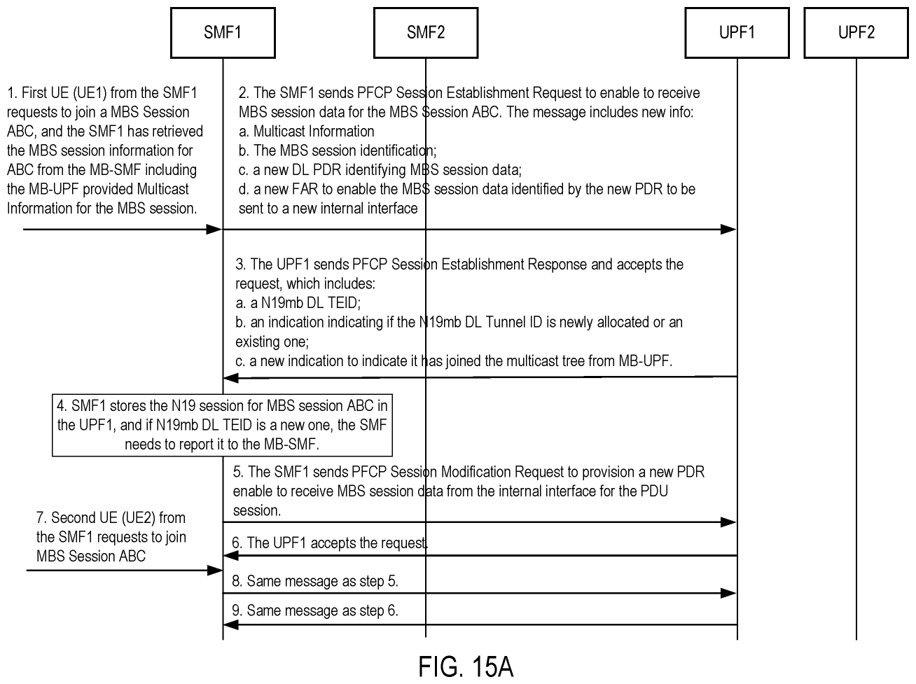

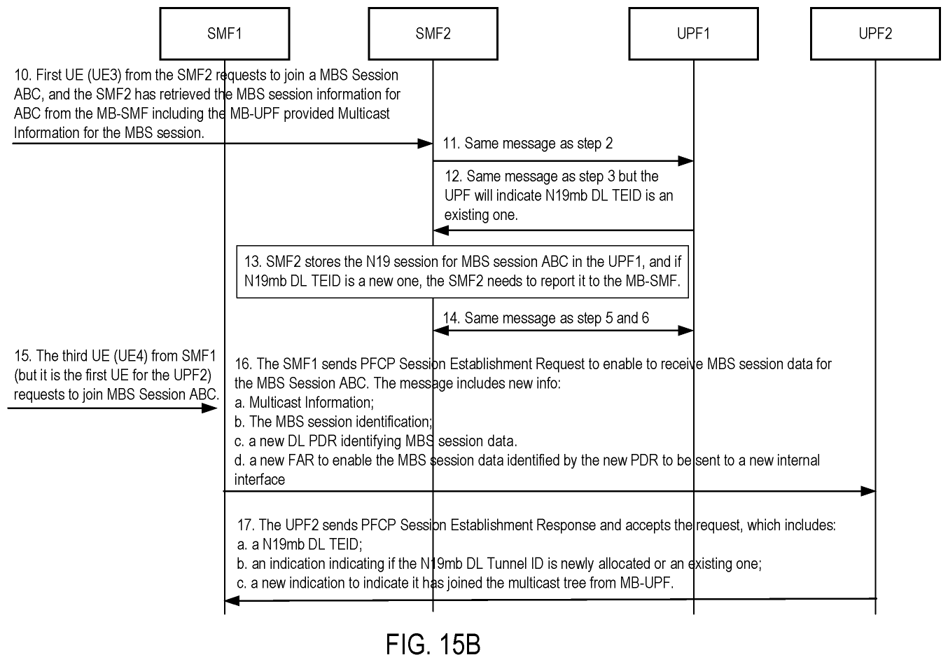

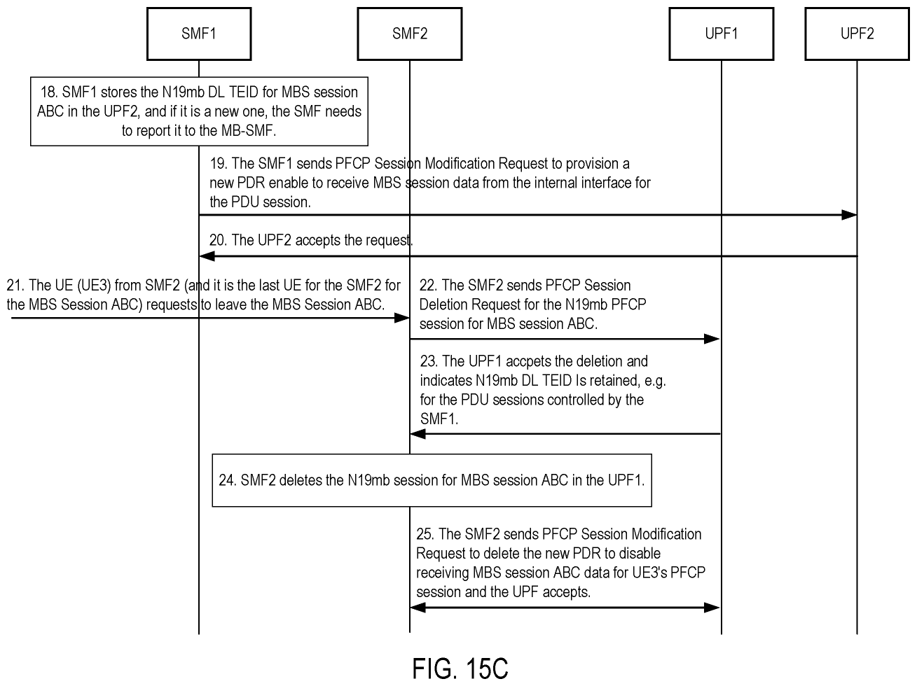

### FIGS. 15A-15C

FIGS. 15A-15C are flowcharts illustrating an exemplary process according to an embodiment of the disclosure. At step 1, the first UE (UE1) from the SMF1 requests to join a MBS Session ABC. The SMF1 has retrieved the MBS session information for ABC from the MB-SMF including the MB-UPF provided Multicast Information (Common-TEID, Source IP address, and Multicast IP address) for the MBS session. At step 2, the SMF1 sends a PFCP Session Establishment Request to enable to receive MBS session data for the MBS Session ABC. The message includes the following new information: a) Multicast Information (Common TEID, Source IP addr, Multicast IP addr); b) The MBS session identification; c) a new DL PDR identifying MBS session data which is received at a local Tunnel Endpoint Tunnel at the UPF where the ID of tunnel is to be allocated by the UPF, which may be called N19mb DL TEID; d) a new FAR to enable the MBS session data identified by the new PDR to be sent to an internal interface.

At step 3, the UPF1 sends a PFCP Session Establishment Response and accepts the request, which includes: a) a N19mb DL TEID; b) an indication indicating if the N19mb DL Tunnel ID is newly allocated or an existing one; c) a new indication to indicate it has joined the multicast tree from MB-UPF, e.g. when no N19mb DL TEID is included. At step 4, the SMF1 stores the N19 session for MBS session ABC in the UPF1. If N19mb DL TEID is a new one, the SMF1 needs to report it to the MB-SMF.

At step 5, the SMF1 sends a PFCP Session Modification Request to provision a new PDR enable to receive MBS session data from the internal interface for the PDU session. At step 6, the UPF1 accepts the request. At step 7, the second UE (UE2) from the SMF1 requests to join MBS Session ABC. At step 8, the same message as step 5 is sent from the SMF1 to the UPF1. At step 9, the same message as step 6 is sent from the UPF1 to the SMF1.

At step 10, the first UE (UE3) from the SMF2 requests to join a MBS Session ABC. The SMF2 has retrieved the MBS session information for ABC from the MB-SMF including the MB-UPF provided Multicast Information (Common-TEID, Source IP address, and Multicast IP address) for the MBS session. At step 11, the same message as step 2 is sent from the SMF2 to the UPF1. At step 12, the same message as step 3 is sent from the UPF1 to the SMF2, but the UPF1 will indicate N19mb DL TEID is an existing one. At step 13, the SMF2 stores the N19 session for MBS session ABC in the UPF1. If N19mb DL TEID is a new one, the SMF2 needs to report it to the MB-SMF. At step 14, the same messages as steps 5 and 6 are communicated between the SMF2 and the UPF1.

At step 15, the third UE (UE4) from the SMF1 (but it is the first UE for the UPF2) requests to join MBS Session ABC. At step 16, the SMF1 sends a PFCP Session Establishment Request to enable to receive MBS session data for the MBS Session ABC. The message includes the following new information: a) Multicast Information (Common TEID, Source IP addr, Multicast IP addr); b) The MBS session identification; c) a new DL PDR identifying MBS session data which is received at a local Tunnel Endpoint Tunnel at the UPF where the ID of tunnel is to be allocated by the UPF, which may be called N19mb DL TEID; d) a new FAR to enable the MBS session data identified by the new PDR to be sent to an internal interface.

At step 17, the UPF2 sends a PFCP Session Establishment Response and accepts the request, which includes: a) a N19mb DL TEID; b) an indication indicating if the N19mb DL Tunnel ID is newly allocated or an existing one; c) a new indication to indicate it has joined the multicast tree from MB-UPF, e.g. when no N19mb DL TEID is included. At step 18, the SMF1 stores the N19mb DL TEID for MBS session ABC in the UPF2. If it is a new one, the SMF needs to report it to the MB-SMF. At step 19, the SMF1 send a PFCP Session Modification Request to provision a new PDR enable to receive MBS session data from the internal interface for the PDU session. At step 20, the UPF2 accepts the request.

At step 21, the first UE (UE3) from the SMF2 (and it is the last UE for the SMF2 for the MBS Session ABC) requests to leave the MBS Session ABC. At step 22, the SMF2 sends a PFCP Session Deletion Request for the N19mb PFCP session for MBS session ABC. At step 23, the UPF1 accepts the deletion and indicates N19mb DL TEID is retained, e.g. for the PDU sessions being controlled by the SMF1. At step 24, the SMF2 deletes the N19mb session for MBS session ABC in the UPF1. At step 25, the SMF2 sends a PFCP Session Modification Request to delete the new PDR to disable receiving MBS session ABC data for UE3's PFCP session and the UPF accepts.

Hereinafter, some additional proposals will be described in detail.

In 3GPP TS 23.247 V1.0.0, clause 7.2.1.3 describes the MBS Session Join procedure and clause 7.2.2.2 describes the MBS Session Leave procedure. In clause 7.2.1.3, when a UE joins an MBS session in PDU Session Modification Request, the SMF performs step 4 as described below, if the MB-SMF has no information of the MBS session:
4. By using Nmbsmf_Information_Request request (MBS Session ID). SMF interacts with the MB-SMF to retrieve multicast QoS flow information of the indicated MBS session. For multicast transport between MB-UPF and content provider, if it is the first UE joining the multicast group, and MB-UPF has not joined the multicast tree in the MBS configuration procedure, the MB-SMF requests the MB-UPF to join the multicast tree towards the AF/MBSF, otherwise MB-SMF will not send the request to the MB-UPF.

It is not a pure Information Request operation. After the SMF fetches the multicast QoS flow information of the MBS session, the SMF subscribes the MBS session implicitly in the MB-SMF. The SMF is expected to be notified for the MBS session updates afterwards. For example, in case the MB-SMF handles session update, session release, session activation and session deactivation requests, the MB-SMF needs to notify the SMF so that the SMF can take the corresponding actions accordingly.

Thus, as Proposal-1, the SMF shall subscribe the MBS session implicitly in the MB-SMF when it retrieves multicast QoS flow information of the MBS session.

In clause 7.2.1.3, if 5GC individual MBS traffic delivery applies to the UE, step 11 is performed as below:

[Conditional] Step 11 is used for 5GC Individual MBS traffic delivery. e.g. the related NG-RAN does not support multicast. If the shared tunnel between the UPF(PSA) and MB-UPF for individual delivery have not been established, steps 11a to 11e are executed.
11a. If unicast transport for the multicast data between UPF and MB-UPF is to be used. SMF allocates a downlink tunnel endpoint and configures UPF. Or, SMF requests UPF to allocate a downlink tunnel ID.
11b. SMF invokes Nmbsmf_Reception_Request request (MBS Session ID. DL tunnel info) towards MB-SMF that includes MBS Session ID and downlink tunnel info of UPF, for establishing the multicast session distribution between MB-UPF and UPF.
11c. MB-SMF configures MB-UPF to transmit the multicast distribution session towards UPF using the received downlink tunnel ID.
11d. MB-SMF responds to SMF through Nmbsmf_Reception_Request response. For multicast transport between MB-UPF and UPF, it also indicates in the downlink tunnel information and the transport multicast address for the multicast session.
11e. For multicast transport between MB-UPF and UPF. SMF configures UPF to receive the multicast distribution session and forwards the data within unicast transport.

It is true that step 11 is for 5GC individual MBS traffic delivery. However, it is not correct to state: “If the shared tunnel between the UPF(PSA) and MB-UPF for individual delivery have not been established, steps 11a to 11e are executed.” The intention of step 11 is to configure UPF to be able to distribute the MBS session data received over N19mb interface towards the PDU session. If the shared tunnel has been established, the SMF still needs to inform the UPF so that the MBS session data can be distributed towards the UE.

Thus, as Proposal-2, Step 11a. and step 11e. are always needed, regardless whether the shared tunnel has been established or not.

For an MBS session, the UPF may serve UEs which are distributed in multiple SMFs. For unicast transport of N19mb, it can only be the UPF to allocate the downlink tunnel ID, instead of the SMF. Otherwise, several SMFs may allocate different downlink tunnel IDs when they receive join requests from multiple UEs in parallel.

Thus, as Proposal-3, for unicast transport of N19mb, let the UPF to allocate downlink tunnel ID, instead of the SMF. The UPF includes the downlink tunnel ID in the response to the SMF.

For unicast transport of N19mb, the shared tunnel between the UPF and the MB-UPF only need to be established once. And thus, the request of establishing shared tunnel from the SMF to the MB-SMF, it only needs to be sent once per MBS session. The MB-SMF and the MB-UPF may be robust enough to handle duplicated information sent from the same SMF or from multiple SMFs. However, it is not efficient and unnecessary.

For example, assume UE1 and UE2 join the multicast session in SMF1, UE3 and UE4 join the same multicast session in SMF2, and all 4 UEs are served by UPF1 using individual delivery. And further assume UE1 is the first UE join the MBS session in SMF1 and UPF1. In this case, UPF1 needs to allocate downlink tunnel ID of the MBS session for UE1, and SMF1 needs to pass the downlink tunnel ID to the MB-SMF when UE1 joins as well. It is unnecessary for SMF1 to interact with the MB-SMF when UE2 joins. It is also unnecessary for SMF2 to interact with the MB-SMF when UE3 and UE4 join.

It can be achieved by an indication from the UPF to the SMF. The indication can be the presence of the downlink tunnel ID or an additional parameter. That is, the UPF may only include the downlink tunnel ID in the response to the SMF when the first UE in the UPF joined the MBS session, so that there is only one SMF can pass the information to the MB-SMF for the shared tunnel establishment. It is also possible that the UPF includes the downlink tunnel ID in every response to the SMF but introduces an additional parameter (e.g. setupDownlink Tunnel) when the first UE in the UPF joined the MBS session.

Thus, as Proposal-4, for unicast transport of N19mb, the shared tunnel between the UPF and the MB-UPF only needs to be established once. And for one MBS session in one UPF, the request from the SMF to the MB-SMF needs to be sent once as well, even when there are multiple SMFs serving the UEs joined the MBS session.

For multicast transport of N19mb, the UPF can simply join the SSM group (LL MC) to receive the data of MBS session. And the SMF can fetch the multicast transportation information of the MBS session from the MB-SMF in step 4. It is not efficient and unnecessary for the SMF to get such information by executing step 11a to 11d.

Thus, as Proposal-5, for multicast transport of N19mb, the SMF can fetch the multicast transport information of the MBS session in step 4. And then, step 11e. can be executed directly, while 11a to 11d can be skipped

Thus, as Proposal-6, based on Proposal-2 and Proposal-5, step 11a and step 11e can be combined as one step. Step 11b to step 11d can be skipped if shared tunnel has been established or UPF has joined the multicast group for the MBS session.

In clause 7.2.2.2, after receiving PDU Session Modification Request, the SMF performs step 3 as described below:
3. [conditional] If the UE is the last UE served with 5GC Individual MBS traffic delivery method in this UPF for this MBS session, the SMF configures the UPF to stop receiving multicast data from the MB-UPF and invokes Nmbsmf_MBSession_Update Request (MBS session ID. [tunnel information]) to release the tunnel between UPF and MB-UPF for this MBS session.

However, to release the shared tunnel between the UPF and the MB-UPF, it should only be done when the last UE using individual MBS traffic delivery method in the UPF leaves the multicast session.

Without interaction with the UPF, the SMF cannot determine such scenario, as there could be the UEs in multiple SMFs are served by the same UPF. For example, assume UE1 and UE2 joined the multicast session in SMF1, UE3 and UE4 joined the same multicast session in SMF2. And all 4 UEs are served by UPF1 using individual delivery. UE1 and UE2 leave the multicast session should not cause the release of the shared tunnel between the UPF1 and the MB-UPF, if UE3 or UE4 are still joined.

Thus, as Proposal-7, the SMF should interact with the UPF prior to the release of the shared tunnel between the UPF and the MB-UPF. It should be the UPF to indicate to the SMF when the shared tunnel can be released.

In clause 7.2.1.3 “Multicast session join and session establishment procedure”, in step 4, the SMF interacts with the MB-SMF to retrieve the information of the MBS session. Afterwards, if there are further changes of the MBS session (e.g. activation, deactivation, update, release, etc.), the MB-SMF would inform the SMF as described in clause 7.2.5.2 “MBS session activation procedure”, 7.2.5.3 “MBS session deactivation procedure”, 7.2.6 “Multicast session update procedure”, 7.2.2.3 “SMF removing joined UEs from MBS session”. And then the SMF can take the proper actions towards the joined UEs.

There is an implicit subscribe of the MBS session when the SMF interacts with the MB-SMF to retrieve the MBS session information.

After the last UE in the SMF leaves the MBS session, the MB-SMF is not expected to further inform the SMF of the changes of the MBS session. There need to be an unsubscribe of the MBS session when the last UE in the SMF leaves the MBS session.

Thus, as Proposal-8, the SMF needs to unsubscribe the MBS session towards the MB-SMF, if the last UE in the SMF leaves the MBS session.

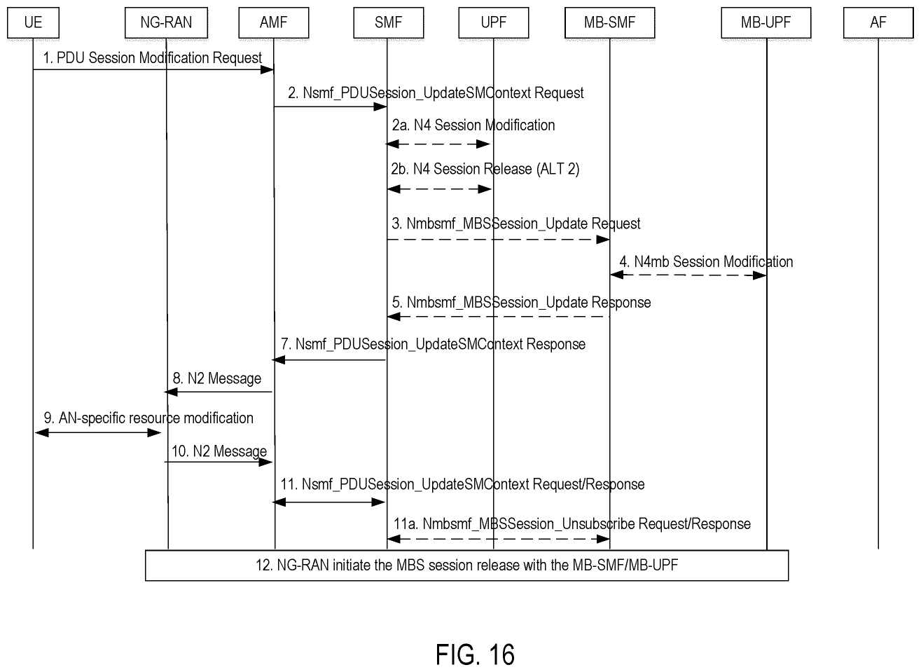

### FIG. 16

Based on the above description, the following changes are suggested to be made to 3GPP TS 23.247 V1.0.0, where the added contents are highlighted with underlines and the content within “[ . . . ]” refers to the content proposed to be deleted. In addition, FIG. 7.2.2.2-1 (“UE initiated multicast MBS session leave”) in 3GPP TS 23.247 V1.0.0 is suggested to be replaced with FIG. 16.

7.2.1.3 Multicast session join and session establishment procedure
4. By using Nmbsmf_Information_Request request (MBS Session ID). SMF interacts with the MB-SMF to retrieve multicast QoS flow information and the multicast transport information of the indicated MBS session. The SMF subscribes the MBS session implicitly in the MB-SMF, so that the SMF will be notified when there are updates of the MBS session. For multicast transport between MB-UPF and content provider, if it is the first UE joining the multicast group, and MB-UPF has not joined the multicast tree in the MBS configuration procedure, the MB-SMF requests the MB-UPF to join the multicast tree towards the AF/MBSF, otherwise MB-SMF will not send the request to the MB-UPF.

[Conditional] Step 11 is used for 5GC Individual MBS traffic delivery. e.g. the related NG-RAN does not support multicast.
11a. Alternative 1: The SMF sends PFCP session modification request for the PDU session to the UPF, including MBS session ID, multicast transport information ([common DL tunnel ID], [LL SSM]), a new PDR and the associated FAR.

Alternative 2: If the PFCP session for N19mb hasn't been established (i.e. the first UE in the SMF joins the MBS session), the SMF sends PFCP session establishment request to the UPF, including MBS session ID, multicast transport information ([common DL tunnel ID]. ILL SSM])

If the UPF prefers the multicast transport, it can join the source specific multicast group to receive the MBS session data when the first UE in the UPF joined the MBS session. If the UPF prefers the unicast transport, it allocates a N19mb DL tunnel ID for the MBS session if it hasn't been allocated. The UPF sends PFCP session modification response (alternative 1) and PFCP session establishment response (alternative 2) to the SMF, including N19mb DL tunnel ID, an indication whether the DL tunnel is newly allocated, an indication whether UPF has joined the multicast group without allocating DL tunnel.
11b. If the N19mb DL tunnel ID is received and the DL tunnel ID is newly allocated, the SMF invokes Nmbsmf_Reception_Request request (MBS Session ID. DL tunnel info) towards MB-SMF that includes MBS Session ID and downlink tunnel info of UPF, for establishing the multicast session distribution between MB-UPF and UPF.
11c. MB-SMF configures MB-UPF to transmit the multicast distribution session towards UPF using the received downlink tunnel ID.
11d. MB-SMF responds to SMF through Nmbsmf_Reception_Request response.
11e. In alternative 2, after dedicated PFCP session for N19mb is established, the SMF sends PFCP session modification request for the PDU session to the UPF with the new PDR receiving MBS session data from an internal interface of the UPF, and forwards the data within unicast transport via an existing FAR.

7.2.2.2 MBS session Leave
2. The AMF invokes Nsmf_PDUSession_UpdateSMContext to SMF. The MBS session leaving information (i.e. leave indication. MBS session ID) is included.
2a. [Optional] If individual delivery is applied, the SMF sends an N4 Session Modification Request to the UPF (PSA). The SMF reconfigures UPF to terminate the distribution of multicast data via the unicast PDU session.
   The UPF (PSA) sends an N4 Session Modification Response to the SMF.
   For Alternative 1, if the last UE leaves the MBS session in the UPF, the UPF release N19mb DL tunnel if unicast transport is used or leaves the multicast group if the multicast transport is used. The UPF will also include an indication in the N4 Session Modification Response about whether the SMF should inform the MB-SMF of the release of the N19mb DL tunnel.
2b. For Alternative 2, if the SMF determines the last UE in the SMF leaves the MBS session, the SMF sends N4 Session Delete Request to the UPF. If no other SMFs have PFCP associated with the MBS session, the UPF release N19mb DL tunnel if unicast transport is used or leaves the multicast group if the multicast transport is used. The UPF will also include an indication in the N4 Session Deletion Response about whether the SMF should inform the MB-SMF of the release of the N19mb DL tunnel.
3. [conditional] If the UPF released the N19mb DL tunnel and indicating the SMF should inform the MB-SMF, the SMF invokes Nmbsmf_MBSession_Update Request (MBS session ID. [tunnel information]) to release the tunnel between UPF and MB-UPF for this MBS session.
   If unicast transport is used, tunnel information is included to indicate the tunnel between UPF and MB-UPF.
4. [conditional] The MB-SMF request to MB-UPF to release the tunnel between UPF and MB-UPF for the MBS session.
5. [conditional] The MB-SMF responds to SMF for step 3.
11. The AMF transfers the N2 message received in step 9 to the SMF via the Nsmf_PDUSession UpdateSMContext service operation.
The SMF removes the UE from the MBS Session. In addition, if dedicated QOS flow is used for the unicast transfer of the multicast data, the SMF also removes the unicast QoS flow information associated with the indicated MBS session form the UE SM context.
11a. If the UE is the last joined one of the MBS session in the SMF, the SMF invokes the MB-SMF via the Nmbsmf_MBSSession Unsubscribe service operation. And the MB-SMF will no longer notify/invoke the SMF for the further change of the MBS session (e.g., activation, deactivation, update, release, etc.).
12. If the UE is the last UE in this RAN node for this MBS session, the NG-RAN release MBS session between NG-RAN and MB-UPF.

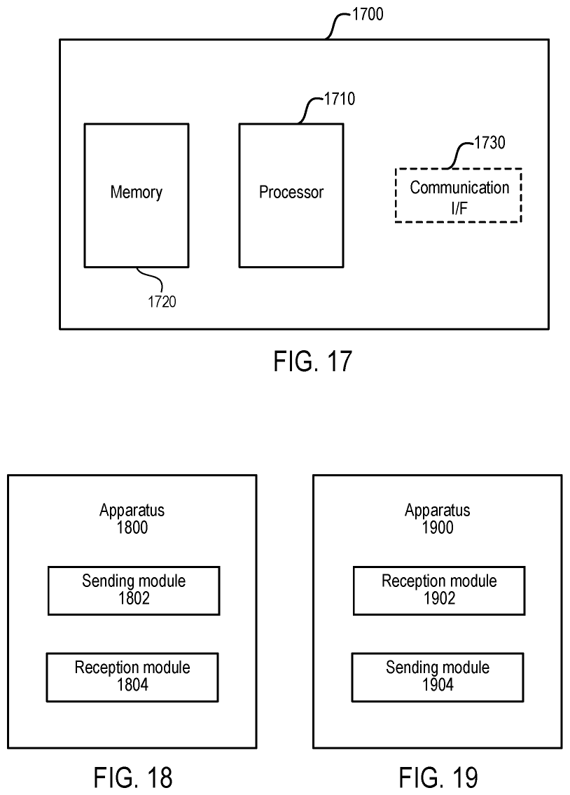

### FIG. 17

FIG. 17 is a block diagram showing an apparatus suitable for use in practicing some embodiments of the disclosure. For example, any one of the SMF and the UPF described above may be implemented through the apparatus 1700. As shown, the apparatus 1700 may include a processor 1710, a memory 1720 that stores a program, and optionally a communication interface 1730 for communicating data with other external devices through wired and/or wireless communication.

The program includes program instructions that, when executed by the processor 1710, enable the apparatus 1700 to operate in accordance with the embodiments of the present disclosure, as discussed above. That is, the embodiments of the present disclosure may be implemented at least in part by computer software executable by the processor 1710, or by hardware, or by a combination of software and hardware.

The memory 1720 may be of any type suitable to the local technical environment and may be implemented using any suitable data storage technology, such as semiconductor based memory devices, flash memories, magnetic memory devices and systems, optical memory devices and systems, fixed memories and removable memories. The processor 1710 may be of any type suitable to the local technical environment, and may include one or more of general purpose computers, special purpose computers, microprocessors, digital signal processors (DSPs) and processors based on multi-core processor architectures, as non-limiting examples.

### FIG. 18

FIG. 18 is a block diagram showing an apparatus implementing an SMF according to an embodiment of the disclosure. As shown, the apparatus 1800 comprises a sending module 1802 and a reception module 1804. The sending module 1802 may be configured to send, to a UPF, a first request for modifying a PFCP session for a PDU session associated with an MBS session. The first request may comprise an identification of the MBS session. The reception module 1804 may be configured to receive, from the UPF, a first response to the first request.

### FIG. 19

FIG. 19 is a block diagram showing an apparatus implementing a UPF according to an embodiment of the disclosure. As shown, the apparatus 1900 comprises a reception module 1902 and a sending module 1904. The reception module 1902 may be configured to receive, from an SMF, a first request for modifying a PFCP session for a PDU session associated with an MBS session. The first request may comprise an identification of the MBS session. The sending module 1904 may be configured to send, to the SMF, a first response to the first request.

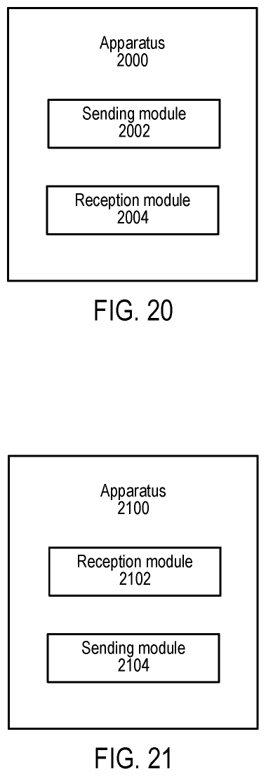

### FIG. 20

FIG. 20 is a block diagram showing an apparatus implementing an SMF according to an embodiment of the disclosure. As shown, the apparatus 2000 comprises a sending module 2002 and a reception module 2004. The sending module 2002 may be configured to send, to a UPF, a first request for establishing a first PFCP session for an MBS session. The first request may comprise an identification of the MBS session. The reception module 2004 may be configured to receive, from the UPF, a first response to the first request.

### FIG. 21

FIG. 21 is a block diagram showing an apparatus implementing a UPF according to an embodiment of the disclosure. As shown, the apparatus 2100 comprises a reception module 2102 and a sending module 2104. The reception module 2102 may be configured to receive, from an SMF, a first request for establishing a first PFCP session for an MBS session. The first request may comprise an identification of the MBS session. The sending module 2104 may be configured to send, to the SMF, a first response to the first request. The modules described above may be implemented by hardware, or software, or a combination of both.

### Some Embodiments

Some Embodiments Described Above may be summarized in the following manner:
1. A method performed by a session management function, SMF, comprising:
   sending (402), to a user plane function, UPF, a first request for modifying a packet forwarding control protocol, PFCP, session for a protocol data unit, PDU, session associated with a multicast broadcast service, MBS, session, wherein the first request comprises an identification of the MBS session; and
   receiving (404), from the UPF, a first response to the first request.
2 The method according to embodiment 1, wherein the first request further comprises information required for receiving data of the MBS session via multicast transport.
3. The method according to embodiment 2, wherein the information required for receiving data of the MBS session via multicast transport comprises:
   a common downlink tunnel identifier, ID; and
   a source specific multicast address, SSM.
4. The method according to any of embodiment 1 to 3, wherein the first request further comprises:
   a packet detection rule, PDR, for identifying the data of the MBS session; and
   a forwarding action rule, FAR, associated with the PDR.
5. The method according to any of embodiment 1 to 4, wherein the PDU session is the first PDU session joining the MBS session in the SMF; and
   wherein the first request indicates the UPF to allocate, for the MBS session, tunnel information about the UPF endpoint of a tunnel between the UPF and a multicast broadcast UPF, MB-UPF.
6. The method according to any of embodiment 1 to 5, wherein the first response comprises:
   tunnel information about the UPF endpoint of a tunnel between the UPF and an MB-UPF; and
   a first indicator indicating whether the tunnel information is newly allocated.
7. The method according to any of embodiment 1 to 6, wherein the first response comprises:
   a second indicator indicating whether the UPF has joined a multicast group for the MBS session without allocating tunnel information about the UPF endpoint of a tunnel between the UPF and an MB-UPF.
8. The method according to embodiment 6, further comprising:
   when the first indicator indicates that the tunnel information is newly allocated, sending (410) the tunnel information to an MB-SMF for establishing a multicast session distribution between the UPF and the MB-UPF.
9. The method according to any of embodiment 1 to 4, wherein tunnel information about the UPF endpoint of a tunnel between the UPF and an MB-UPF has been received and stored previously by the SMF for the MBS session in the UPF; and
   wherein the first request comprises the tunnel information.
10. The method according to any of embodiment 1 to 9, further comprising:
   sending (506), to the UPF, a second request for modifying the PFCP session for the PDU session, wherein the second request indicates the UPF to remove a PDR for identifying the data of the MBS session; and
   receiving (508), from the UPF, a second response to the second request.
11. The method according to embodiment 10, wherein the second response comprises:
   a third indicator indicating whether a tunnel between the UPF and an MB-UPF is to be released.
12. The method according to embodiment 11, further comprising:
   when the third indicator indicates that the tunnel is to be released, sending (512), to an MB-SMF, information about the release of the tunnel.
13. A method performed by a user plane function, UPF, comprising:
   receiving (602), from a session management function, SMF, a first request for modifying a packet forwarding control protocol, PFCP, session for a protocol data unit, PDU, session associated with a multicast broadcast service, MBS, session, wherein the first request comprises an identification of the MBS session; and
   sending (604), to the SMF, a first response to the first request.
14. The method according to embodiment 13, wherein the first request further comprises information required for receiving data of the MBS session via multicast transport.
15. The method according to embodiment 14, wherein the information required for receiving data of the MBS session via multicast transport comprises:
   a common downlink tunnel identifier, ID; and
   a source specific multicast address, SSM.
16. The method according to any of embodiment 13 to 15, wherein the first request further comprises:
   a packet detection rule, PDR, for identifying the data of the MBS session; and
   a forwarding action rule, FAR, associated with the PDR.
17. The method according to any of embodiment 13 to 16, wherein the PDU session is the first PDU session joining the MBS session in the SMF; and
   wherein the first request indicates the UPF to allocate, for the MBS session, tunnel information about the UPF endpoint of a tunnel between the UPF and a multicast broadcast UPF, MB-UPF.
18. The method according to any of embodiment 13 to 17, wherein the first response comprises:
   tunnel information about the UPF endpoint of a tunnel between the UPF and an MB-UPF; and
   a first indicator indicating whether the tunnel information is newly allocated.
19. The method according to any of embodiment 13 to 18, wherein the first response comprises:
   a second indicator indicating whether the UPF has joined a multicast group for the MBS session without allocating tunnel information about the UPF endpoint of a tunnel between the UPF and an MB-UPF.
20. The method according to any of embodiment 13 to 16, wherein tunnel information about the UPF endpoint of a tunnel between the UPF and an MB-UPF has been received and stored previously by the SMF for the MBS session in the UPF; and
   wherein the first request comprises the tunnel information.
21. The method according to any of embodiment 13 to 20, further comprising:
   receiving (706), from the SMF, a second request for modifying the PFCP session for the PDU session, wherein the second request indicates the UPF to remove a PDR for identifying the data of the MBS session; and
   sending (708), to the UPF, a second response to the second request.
22. The method according to embodiment 21, wherein the second response comprises:
   a third indicator indicating whether a tunnel between the UPF and an MB-UPF is to be released.
23. A method performed by a session management function, SMF, comprising:
   sending (802), to a user plane function, UPF, a first request for establishing a first packet forwarding control protocol, PFCP, session for a multicast broadcast service, MBS, session, wherein the first request comprises an identification of the MBS session; and
   receiving (804), from the UPF, a first response to the first request.
24. The method according to embodiment 23, wherein the first request further comprises information required for receiving data of the MBS session via multicast transport.
25. The method according to embodiment 24, wherein the information required for receiving data of the MBS session via multicast transport comprises:
   a common downlink tunnel identifier, ID; and
   a source specific multicast address, SSM.
26. The method according to any of embodiment 23 to 25, wherein the first request further comprises:
   a first packet detection rule, PDR, for identifying the data of the MBS session; and
   a first forwarding action rule, FAR, associated with the first PDR.
27. The method according to any of embodiment 23 to 26, wherein the first request is sent for the first terminal device joining the MBS session in the SMF; and
   wherein the first request indicates the UPF to allocate, for the MBS session, tunnel information about the UPF endpoint of a tunnel between the UPF and a multicast broadcast UPF, MB-UPF.
28. The method according to any of embodiment 23 to 27, wherein the first response comprises:
   tunnel information about the UPF endpoint of a tunnel between the UPF and an MB-UPF; and
   a first indicator indicating whether the tunnel information is newly allocated.
29. The method according to any of embodiment 23 to 28, wherein the first response comprises:
   a second indicator indicating whether the UPF has joined a multicast group for the MBS session without allocating tunnel information about the UPF endpoint of a tunnel between the UPF and an MB-UPF.
30. The method according to embodiment 28, further comprising:
   when the first indicator indicates that the tunnel information is newly allocated, sending (814) the tunnel information to an MB-SMF for establishing a multicast session distribution between the UPF and the MB-UPF.
31. The method according to any of embodiment 23 to 30, further comprising:
   when the first PFCP session has been established, sending (906), to the UPF, a second request for modifying a second PFCP session for a protocol data unit, PDU, session associated with the MBS session, wherein the second request comprises a second PDR for identifying the data of the MBS session from an internal interface of the UPF, and a second FAR for forwarding the data of the MBS session to a terminal device; and
   receiving (908), from the UPF, a second response to the second request.
32. The method according to embodiment 31, further comprising:
   when a last terminal device leaves the MBS session in the SMF, sending (1010), to the UPF, a third request for deleting the first PFCP session; and
   receiving (1012), from the UPF, a third response to the third request.
33. The method according to embodiment 32, wherein the third response comprises:
   a third indicator indicating whether a tunnel between the UPF and an MB-UPF is to be released.
34. The method according to embodiment 33, further comprising:
   when the third indicator indicates that the tunnel is to be released, sending (1016), to an MB-SMF, information about the release of the tunnel.
35. A method performed by a user plane function, UPF, comprising:
   receiving (1102), from a session management function, SMF, a first request for establishing a first packet forwarding control protocol, PFCP, session for a multicast broadcast service, MBS, session, wherein the first request comprises an identification of the MBS session; and
   sending (1104), to the SMF, a first response to the first request.
36. The method according to embodiment 35, wherein the first request further comprises information required for receiving data of the MBS session via multicast transport.
37. The method according to embodiment 36, wherein the information required for receiving data of the MBS session via multicast transport comprises:
   a common downlink tunnel identifier, ID; and
   a source specific multicast address, SSM.
38. The method according to any of embodiment 35 to 37, wherein the first request further comprises:
   a first packet detection rule, PDR, for identifying the data of the MBS session; and
   a first forwarding action rule, FAR, associated with the first PDR.
39. The method according to any of embodiment 35 to 38, wherein the first request is received for the first terminal device joining the MBS session in the SMF; and
   wherein the first request indicates the UPF to allocate, for the MBS session, tunnel information about the UPF endpoint of a tunnel between the UPF and a multicast broadcast UPF, MB-UPF.
40. The method according to any of embodiment 35 to 39, wherein the first response comprises:
   tunnel information about the UPF endpoint of a tunnel between the UPF and an MB-UPF; and
   a first indicator indicating whether the tunnel information is newly allocated.
41. The method according to any of embodiment 35 to 40, wherein the first response comprises:
   a second indicator indicating whether the UPF has joined a multicast group for the MBS session without allocating tunnel information about the UPF endpoint of a tunnel between the UPF and an MB-UPF.
42. The method according to any of embodiment 35 to 41, further comprising:
   when the first PFCP session has been established, receiving (1206), from the SMF, a second request for modifying a second PFCP session for a protocol data unit, PDU, session associated with the MBS session, wherein the second request comprises a second PDR for identifying the data of the MBS session from an internal interface of the UPF, and a second FAR for forwarding the data of the MBS session to a terminal device; and
   sending (1208), to the SMF, a second response to the second request.
43. The method according to embodiment 42, further comprising:
   when a last terminal device leaves the MBS session in the SMF, receiving (1310), from the SMF, a third request for deleting the first PFCP session; and
   sending (1312), to the SMF, a third response to the third request.
44. The method according to embodiment 43, wherein the third response comprises:
   a third indicator indicating whether a tunnel between the UPF and an MB-UPF is to be released.
45. An apparatus (1700) implementing a session management function, SMF, comprising:
   at least one processor (1710); and
   at least one memory (1720), the at least one memory (1720) containing instructions executable by the at least one processor (1710), whereby the apparatus (1700) is operative to:
   send, to a user plane function, UPF, a first request for modifying a packet forwarding control protocol, PFCP, session for a protocol data unit, PDU, session associated with a multicast broadcast service, MBS, session, wherein the first request comprises an identification of the MBS session; and
   receive, from the UPF, a first response to the first request.
46. The apparatus (1700) according to embodiment 45, wherein the apparatus (1700) is operative to perform the method according to any of embodiment 2 to 12.
47. An apparatus (1700) implementing a user plane function, UPF, comprising:
   at least one processor (1710); and
   at least one memory (1720), the at least one memory (1720) containing instructions executable by the at least one processor (1710), whereby the apparatus (1700) is operative to:
   receive, from a session management function, SMF, a first request for modifying a packet forwarding control protocol, PFCP, session for a protocol data unit, PDU, session associated with a multicast broadcast service, MBS, session, wherein the first request comprises an identification of the MBS session; and
   send, to the SMF, a first response to the first request.
48. The apparatus (1700) according to embodiment 47, wherein the apparatus (1700) is operative to perform the method according to any of embodiment 14 to 22.
49. An apparatus (1700) implementing a session management function, SMF, comprising:
   at least one processor (1710); and
   at least one memory (1720), the at least one memory (1720) containing instructions executable by the at least one processor (1710), whereby the apparatus (1700) is operative to:
   send, to a user plane function, UPF, a first request for establishing a first packet forwarding control protocol, PFCP, session for a multicast broadcast service, MBS, session, wherein the first request comprises an identification of the MBS session; and
   receive, from the UPF, a first response to the first request.
50. The apparatus (1700) according to embodiment 49, wherein the apparatus (1700) is operative to perform the method according to any of embodiment 24 to 34.
51. An apparatus (1700) implementing a user plane function, UPF, comprising:
   at least one processor (1710); and
   at least one memory (1720), the at least one memory (1720) containing instructions executable by the
   at least one processor (1710), whereby the apparatus (1700) is operative to:
   receive, from a session management function, SMF, a first request for establishing a first packet forwarding control protocol, PFCP, session for a multicast broadcast service, MBS, session, wherein the first request comprises an identification of the MBS session; and
   send, to the SMF, a first response to the first request.
52. The apparatus (1700) according to embodiment 51, wherein the apparatus (1700) is operative to perform the method according to any of embodiment 36 to 44.
53. A computer readable storage medium storing thereon instructions which when executed by at least one processor, cause the at least one processor to perform the method according to any of embodiment 1 to 44.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by a session management function, SMF, comprising:
sending, to a user plane function, UPF, a first request for modifying a packet forwarding control protocol, PFCP, session for a protocol data unit, PDU, session associated with a multicast broadcast service, MBS, session, wherein the first request comprises an identification of the MBS session; and
receiving, from the UPF, a first response to the first request.

2. The method according to claim 1, wherein the first request further comprises information required for receiving data of the MBS session via multicast transport.

3. The method according to claim 2, wherein the information required for receiving data of the MBS session via multicast transport comprises:
a common downlink tunnel identifier, ID; and
a source specific multicast address, SSM.

4. The method according to claim 1, wherein the first request further comprises:
a packet detection rule, PDR, for identifying the data of the MBS session; and
a forwarding action rule, FAR, associated with the PDR.

5. The method according to claim 1, wherein the PDU session is the first PDU session joining the MBS session in the SMF; and
wherein the first request indicates the UPF to allocate, for the MBS session, tunnel information about the UPF endpoint of a tunnel between the UPF and a multicast broadcast UPF, MB-UPF.

6. The method according to claim 1, wherein the first response comprises:
tunnel information about the UPF endpoint of a tunnel between the UPF and an MB-UPF; and
a first indicator indicating whether the tunnel information is newly allocated.

7. The method according to any of claims 1 to 6 claim 1, wherein the first response comprises:
a second indicator indicating whether the UPF has joined a multicast group for the MBS session without allocating tunnel information about the UPF endpoint of a tunnel between the UPF and an MB-UPF.

8. The method according to claim 6, further comprising:
when the first indicator indicates that the tunnel information is newly allocated, sending the tunnel information to an MB-SMF for establishing a multicast session distribution between the UPF and the MB-UPF.

9. The method according to claim 1, wherein tunnel information about the UPF endpoint of a tunnel between the UPF and an MB-UPF has been received and stored previously by the SMF for the MBS session in the UPF; and
wherein the first request comprises the tunnel information.

10. The method according to claim 1, further comprising:
sending, to the UPF, a second request for modifying the PFCP session for the PDU session, wherein the second request indicates the UPF to remove a PDR for identifying the data of the MBS session; and
receiving, from the UPF, a second response to the second request.

11. The method according to claim 10, wherein the second response comprises:
a third indicator indicating whether a tunnel between the UPF and an MB-UPF is to be released.

12. The method according to claim 11, further comprising:
when the third indicator indicates that the tunnel is to be released, sending (542), to an MB-SMF, information about the release of the tunnel.

13. A method performed by a user plane function, UPF, comprising:
receiving, from a session management function, SMF, a first request for modifying a packet forwarding control protocol, PFCP, session for a protocol data unit, PDU, session associated with a multicast broadcast service, MBS, session, wherein the first request comprises an identification of the MBS session; and
sending, to the SMF, a first response to the first request.

14. The method according to claim 13, wherein the first request further comprises information required for receiving data of the MBS session via multicast transport.

15. The method according to claim 14, wherein the information required for receiving data of the MBS session via multicast transport comprises:
a common downlink tunnel identifier, ID; and
a source specific multicast address, SSM.

16. The method according to claim 13, wherein the first request further comprises:
a packet detection rule, PDR, for identifying the data of the MBS session; and
a forwarding action rule, FAR, associated with the PDR.

17. The method according to claim 13, wherein the PDU session is the first PDU session joining the MBS session in the SMF; and
wherein the first request indicates the UPF to allocate, for the MBS session, tunnel information about the UPF endpoint of a tunnel between the UPF and a multicast broadcast UPF, MB-UPF.

18. The method according to claim 13, wherein the first response comprises:
tunnel information about the UPF endpoint of a tunnel between the UPF and an MB-UPF; and
a first indicator indicating whether the tunnel information is newly allocated.

19. The method according to claim 13, wherein the first response comprises:
a second indicator indicating whether the UPF has joined a multicast group for the MBS session without allocating tunnel information about the UPF endpoint of a tunnel between the UPF and an MB-UPF.

20-22. (canceled)

23. A method performed by a session management function, SMF, comprising:
sending, to a user plane function, UPF, a first request for establishing a first packet forwarding control protocol, PFCP, session for a multicast broadcast service, MBS, session, wherein the first request comprises an identification of the MBS session; and
receiving, from the UPF, a first response to the first request.

24-53. (canceled)
